(19) United States
(12) Patent Application Publication
(10) Pub. No.: US 2025/0267383 A1
(43) Pub. Date: Aug. 21, 2025

(54) HEADREST AND CHAIR, SEAT FOR VEHICULAR APPARATUS AND VEHICULAR APPARATUS INCLUDING THE HEADREST

(71) Applicant: LG Display Co., Ltd., Seoul (KR)

(72) Inventor: MinKyu CHOI, Paju-si (KR)

(73) Assignee: LG Display Co., Ltd., Seoul (KR)

(21) Appl. No.: 19/052,894

(22) Filed: Feb. 13, 2025

(30) Foreign Application Priority Data
Feb. 15, 2024 (KR) 10-2024-0021890

(51) Int. Cl. H04R 1/02; H04R 3/12; H04R 17/00

(52) U.S. Cl. CPC H04R 1/025; H04R 1/023; H04R 3/12; H04R 17/00; H04R 2400/11; H04R 2499/13

(57) ABSTRACT

A headrest includes a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

### CROSS-REFERENCE TO RELATED APPLICATIONS

This application claims the benefit of and priority to Korean Patent Application No. 10-2024-0021890 filed on Feb. 15, 2024, the entirety of which is hereby incorporated by reference for all purposes as if fully set forth herein.

### BACKGROUND

### Technical Field

The present disclosure relates to a headrest and chair, a seat for a vehicular apparatus, and a vehicular apparatus including the same.

### Discussion of the Related Art

Vehicles may include a sound apparatus which outputs a sound, based on an audio signal output from a multimedia device such as a car audio. For example, sound apparatuses applied to vehicles may include a front speaker and a rear speaker, which are configured as a coil type.

### SUMMARY

A sound apparatus of a vehicle may have a limitation in outputting a realistic sound or stereophonic sound of a multichannel through a front speaker and a rear speaker. When the number of speakers increases, the sound apparatus of the vehicle may output a stereophonic sound, but due to a spatial limitation of a vehicle and a size of a speaker based on a coil type, there may be a limitation in increasing the number of speakers.

The inventor has recognized the problems described above and has performed various research and experiments for outputting a sound through a headrest. Based on the various research and experiments, the inventor provides a headrest for outputting a sound and a chair and a vehicular apparatus including the headrest.

Accordingly, embodiments of the present disclosure are directed to a headrest and chair, a seat for a vehicular apparatus, and a vehicular apparatus including the same that substantially obviate one or more of the problems due to limitations and disadvantages of the related art.

An aspect of the present disclosure is to provide a headrest for outputting a sound and a chair, a seat for a vehicular apparatus, and a vehicular apparatus including the headrest.

An aspect of the present disclosure is to provide a headrest for outputting a sound of a clear middle-high pitched sound band and a chair, a seat for vehicular apparatus, and a vehicular apparatus including the headrest.

Another aspect of the present disclosure is directed to providing a headrest for outputting a stereo sound and/or a stereophonic sound and a chair, a seat for vehicular apparatus, and a vehicular apparatus including the headrest.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, a headrest comprises a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

In another aspect, a headrest comprises a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus comprises an enclosure connected to the headrest part, a cushion member at a front surface of the enclosure, and a vibration apparatus configured between the enclosure and the cushion member to output a sound.

In another aspect, a chair comprises a seat part, a backseat part connected to the seat part, and a headrest connected to an upper portion of the backseat part. The headrest comprises a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

In another aspect, a chair comprises a seat part, a backseat part connected to the seat part, and a headrest connected to an upper portion of the backseat part. The headrest comprises a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus comprises an enclosure connected to the headrest part, a cushion member at a front surface of the enclosure, and a vibration apparatus configured between the enclosure and the cushion member to output a sound.

In another aspect, a seat for a vehicular apparatus comprises a seat cushion, a seat back connected to the seat cushion, and a headrest connected to an upper portion of the seat back. The headrest comprises a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

In another aspect, a seat for a vehicular apparatus comprises a seat cushion, a seat back connected to the seat cushion, and a headrest connected to an upper portion of the seat back. The headrest comprises a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus comprises an enclosure connected to the headrest part, a cushion member at a front surface of the enclosure, and a vibration apparatus configured between the enclosure and the cushion member to output a sound.

In another aspect, a vehicular apparatus comprises a seat for vehicular apparatus. The seat for vehicular apparatus comprises a seat cushion, a seat back connected to the seat cushion, and a headrest connected to an upper portion of the seat back. The headrest comprises a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

In another aspect, a vehicular apparatus comprises a seat for a vehicular apparatus. The seat for vehicular apparatus comprises a seat cushion, a seat back connected to the seat cushion, and a headrest connected to an upper portion of the seat back. The headrest comprises a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus comprises an enclosure connected to the headrest part, a cushion member at a front surface of the enclosure, and a vibration apparatus configured between the enclosure and the cushion member to output a sound.

Details of other exemplary embodiments will be included in the detailed description of the disclosure and the accompanying drawings.

According to one or more embodiments of the present disclosure, a headrest for outputting a sound and a chair, a seat for vehicular apparatus, and a vehicular apparatus including the headrest may be provided.

According to one or more embodiments of the present disclosure, a headrest for outputting a sound of a clear middle-high pitched sound band and a chair, a seat for vehicular apparatus, and a vehicular apparatus including the headrest may be provided.

According to one or more embodiments of the present disclosure, a headrest for outputting a stereo sound and/or a stereophonic sound and a chair, a seat for vehicular apparatus, and a vehicular apparatus including the headrest may be provided.

According to one or more embodiments of the present disclosure, in a sound generating apparatus, a vibration element and a signal supply member may be configured as one component (or one part or one element), and thus, an effect of uni-materialization may be obtained.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing general description and the following detailed description are exemplary and explanatory and are intended to provide further explanation of the inventive concepts as claimed.

### BRIEF DESCRIPTION OF THE DRAWINGS

The accompanying drawings, which are included to provide a further understanding of the disclosure, are incorporated in and constitute a part of this application, illustrate embodiments of the disclosure and together with the description serve to explain principles of the disclosure.

FIG. 1 is a perspective view illustrating a headrest according to an embodiment of the present disclosure.

FIG. 2 is a perspective view illustrating an embodiment where a sheath member on the headrest illustrated in FIG. 1 has been removed.

FIG. 3 is an exploded perspective view illustrating a headrest according to an embodiment of the present disclosure.

FIG. 4 is a cross-sectional view taken along line I-I′ illustrated in FIG. 2.

FIG. 5 is a cross-sectional view taken along line II-II′ illustrated in FIG. 2.

FIG. 6 is a perspective view illustrating a headrest according to another embodiment of the present disclosure.

FIG. 7 is a perspective view illustrating an embodiment where a sheath member on the headrest illustrated in FIG. 6 has been removed.

FIG. 8 is a plan view illustrating a headrest according to another embodiment of the present disclosure.

FIG. 9 is an exploded perspective view illustrating a headrest part illustrated in FIGS. 6 to 8 according to an embodiment of the present disclosure.

FIG. 10 is an exploded perspective view illustrating a first sound generating apparatus illustrated in FIGS. 6 to 8 according to an embodiment of the present disclosure.

FIG. 11 is a cross-sectional view taken along line III-III′ illustrated in FIG. 10.

FIG. 12 is an exploded perspective view illustrating a second sound generating apparatus illustrated in FIGS. 6 to 8 according to an embodiment of the present disclosure.

FIG. 13 is a cross-sectional view taken along line IV-IV′ illustrated in FIG. 12.

FIG. 14 is a rear view illustrating a headrest according to another embodiment of the present disclosure.

FIG. 15 is a perspective view illustrating a headrest according to another embodiment of the present disclosure.

FIG. 16 is a cross-sectional view taken along line V-V′ illustrated in FIG. 14.

FIG. 17 is a perspective view illustrating a vibration element according to an embodiment of the present disclosure.

FIG. 18 is a cross-sectional view taken along line VI-VI′ illustrated in FIG. 17.

FIG. 19 is a cross-sectional view taken along line VII-VII′ illustrated in FIG. 17.

FIG. 20 is a perspective view illustrating a vibration layer according to another embodiment of the present disclosure.

FIG. 21 is a perspective view illustrating a vibration layer according to another embodiment of the present disclosure.

FIG. 22 is a perspective view illustrating a vibration element according to another embodiment of the present disclosure.

FIG. 23 is a perspective view illustrating a chair according to an embodiment of the present disclosure.

FIG. 24 is a perspective view illustrating a seat for vehicular apparatus according to an embodiment of the present disclosure.

FIG. 25 is a plan view illustrating a vehicular apparatus according to an embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description.

In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The term “at least one” should be understood as including any and all combinations of one or more of the associated listed items. For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, example embodiments of a light emitting display apparatus according to the present disclosure will be described in detail with reference to the accompanying drawings. For convenience of description, a scale of each of elements illustrated in the accompanying drawings differs from a real scale, and thus, is not limited to a scale illustrated in the drawings.

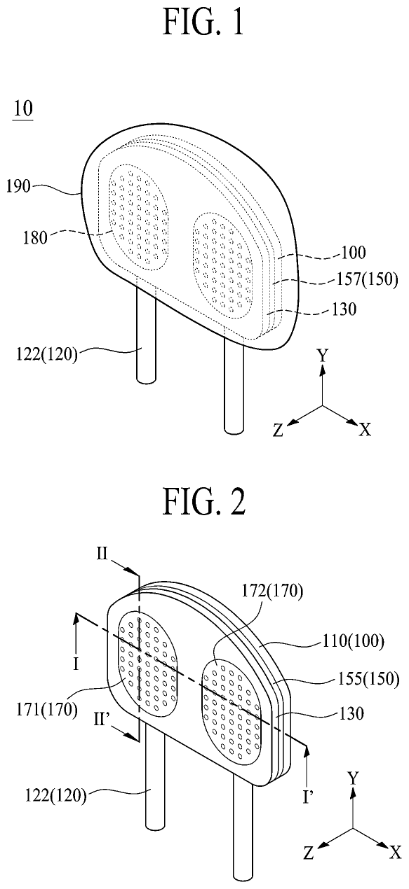

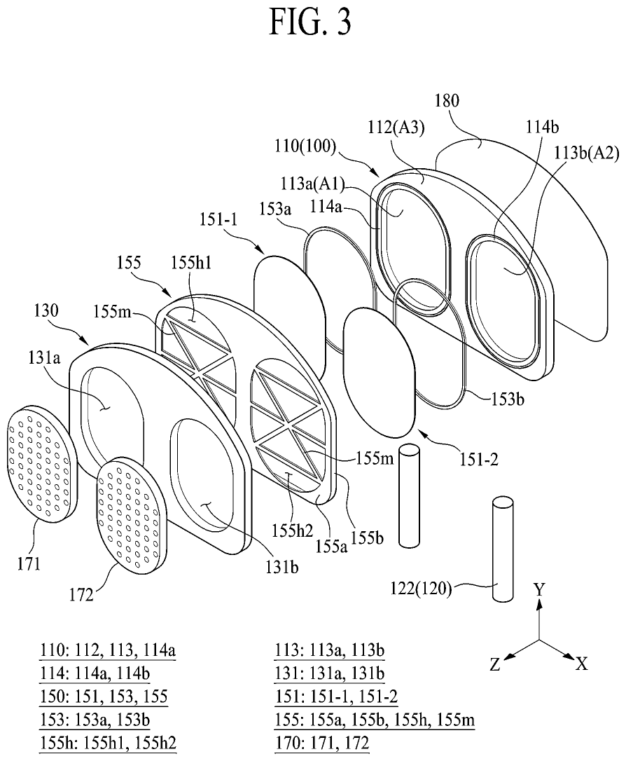

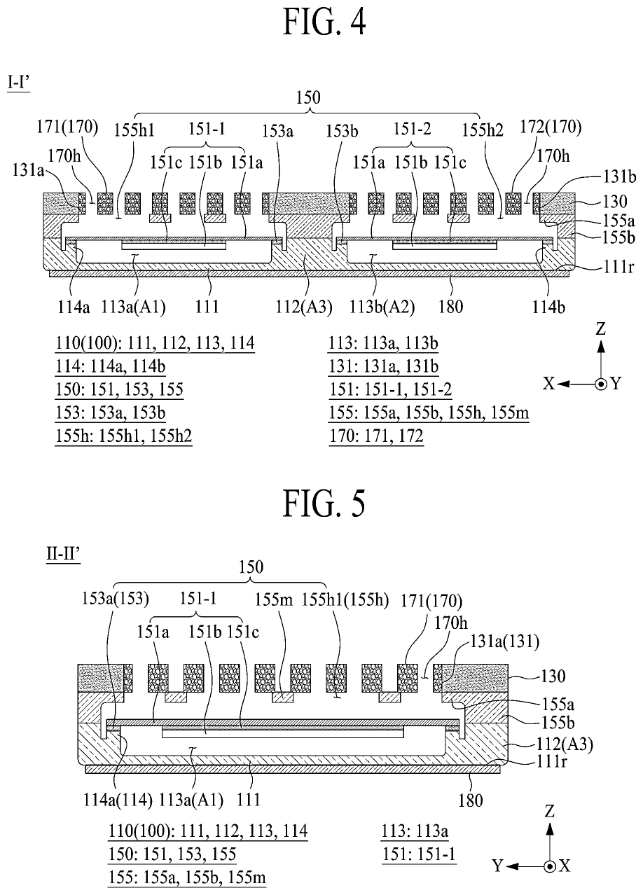

FIG. 1 is a perspective view illustrating a headrest according to an embodiment of the present disclosure. FIG. 2 is a perspective view illustrating an embodiment where a sheath member on the headrest illustrated in FIG. 1 has been removed. FIG. 3 is an exploded perspective view illustrating a headrest according to an embodiment of the present disclosure. FIG. 4 is a cross-sectional view taken along line I-I′ illustrated in FIG. 2. FIG. 5 is a cross-sectional view taken along line II-II′ illustrated in FIG. 2.

Referring to FIGS. 1 to 5, a headrest 10 according to an embodiment of the present disclosure may be configured to output a sound. For example, the headrest 10 may be configured to output a left channel sound and a right channel sound. For example, the headrest 10 may be configured to output a 2-channel stereo sound including the left channel sound and the right channel sound. For example, the headrest 10 may be a headrest apparatus, a headrest speaker, a headrest speaker apparatus, a headrest for chair, a headrest speaker for chair, a headrest speaker apparatus for chair, a headrest for vehicular apparatus, a headrest speaker for vehicular apparatus, and a headrest speaker apparatus for vehicular apparatus, but embodiments of the present disclosure are not limited thereto.

The headrest 10 may include a headrest part 100, a support rod part 120, a cushion member 130, a sound generating apparatus, and a sheath member (or an outer member or an outer skin member) 190.

The headrest part 100 may include a headrest frame 110. For example, the headrest part 100 or the headrest frame 110 may be a body of the headrest 10, a main structure, a housing, or an enclosure, but embodiments of the present disclosure are not limited thereto. For example, the headrest part 100 or the headrest frame 110 may include a tetragonal shape or a tetragonal shape including a curved portion, but embodiments of the present disclosure are not limited thereto.

The headrest part 100 or the headrest frame 110 according to an embodiment of the present disclosure may be configured in a plastic material such as plastic or styrene material, but embodiments of the present disclosure are not limited thereto.

The plastic material of the headrest part 100 or the headrest frame 110 may be configured in polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but embodiments of the present disclosure are not limited thereto.

The material of the headrest part 100 or the headrest frame 110 may be an ABS material. The ABS material may be acrylonitrile, butadiene, and styrene.

The headrest part 100 or the headrest frame 110 according to an embodiment of the present disclosure may be configured to accommodate a sound generating apparatus 150. For example, the headrest part 100 or the headrest frame 110 may be configured to accommodate a driving circuit part for driving the sound generating apparatus 150, but embodiments of the present disclosure are not limited thereto.

The headrest part 100 or the headrest frame 110 according to an embodiment of the present disclosure may include a base frame 111 and an accommodating portion 113.

The base frame 111 may include a tetragonal shape or a tetragonal shape including a curved portion, but embodiments of the present disclosure are not limited thereto. The base frame 111 may include a first surface (or a front surface) and a second surface (or a rear surface) 111r.

The accommodating portion 113 may be formed or configured in the base frame 111. For example, the accommodating portion 113 may be formed or configured in the base frame 111 to accommodate or support the sound generating apparatus 150. For example, the accommodating portion 113 may be formed or configured in the base frame 111 by a protrusion portion 112 protruding from the first surface of the base frame 111. For example, the accommodating portion 113 may be an accommodating space, a groove, an accommodating groove, or a supporting groove, but embodiments of the present disclosure are not limited thereto.

The base frame 111 according to an embodiment of the present disclosure may include a first region A1, a second region A2, and a third region A3.

The first region A1 may be one region or a left region of the base frame 111. The second region A2 may be the other region or a right region of the base frame 111. The first region A1 and the second region A2 may be disposed or configured in parallel.

The third region A3 may surround the first region A1 and the second region A2. For example, the third region A3 may be disposed to surround each of the first region A1 and the second region A2. For example, the third region A3 may include the protrusion portion 112 surrounding each of the first region A1 and the second region A2. For example, the protrusion portion 112 may protrude from the third region A3 of the base frame 111 and may thus provide the accommodating portion 113 of the base frame 111.

The accommodating portion 113 of the base frame 111 may include a first accommodating portion 113a and a second accommodating portion 113b.

The first accommodating portion 113a may be in the first region A1 of base frame 111. For example, the first accommodating portion 113a may be provided by the protrusion portion 112 surrounding the first region A1 of the first to third regions A1, A2, A3 of the base frame 111.

The second accommodating portion 113b may be in the second region A2 of base frame 111. For example, the second accommodating portion 113b may be provided by the protrusion portion 112 surrounding the second region A2 of the first to third regions A1, A2, A3 of the base frame 111.

Each of the first accommodating portion 113a and the second accommodating portion 113b may be provided in the base frame 111 by the protrusion portion 112 and may have a height corresponding to a height of the protrusion portion 112.

The support rod part 120 may be configured to be connected (or coupled) to the headrest part 100 or the headrest frame 110 or support the headrest part 100 or the headrest frame 110.

The support rod part 120 according to an embodiment of the present disclosure may include one or more support rods 122.

The one or more support rods 122 may be configured to be connected to a lower surface of the headrest part 100 or the headrest frame 110. For example, the one or more support rods 122 may be configured to be connected to the base frame 111. For example, the one or more support rods 122 may be configured to be connected to the lower surface of the base frame 111. For example, the support rod part 120 may include a pair of support rods 122. For example, the one or more (or a pair of) support rods 122 may be connected to an upper portion of a seatback of a seat for vehicle or a backrest frame of a chair.

The cushion member 130 may be configured at a front surface of the headrest frame 110. For example, the cushion member 130 may be configured to cover the front surface of the headrest frame 110. The cushion member 130 may be configured to have a same size and shape as those of the headrest frame 110, but embodiments of the present disclosure are not limited thereto. For example, the cushion member 130 may include a material which absorbs an impact. For example, the cushion member 130 may include a foam material or a sponge material, but embodiments of the present disclosure are not limited thereto.

The cushion member 130 according to an embodiment of the present disclosure may include a hollow portion 131 overlapping (or corresponding to) the accommodating portion 113 of the headrest frame 110.

The hollow portion 131 may be a path through which a sound generated (or output) by the sound generating apparatus 150 is output to the outside. For example, the hollow portion 131 may be configured to pass through the cushion member 130 in a thickness direction Z of the cushion member 130.

The hollow portion 131 according to an embodiment of the present disclosure may include a first hollow portion 131a and a second hollow portion 131b.

The first hollow portion 131a may overlap (or correspond to) the first accommodating portion 113a of the headrest frame 110. The second hollow portion 131b may overlap (or correspond to) the second accommodating portion 113b of the headrest frame 110.

The sound generating apparatus 150 may be between the headrest frame 110 and the cushion member 130 and may be configured to output a sound. The sound generating apparatus 150 may be accommodated into or supported by the accommodating portion 113 of the headrest frame 110 to output a sound. For example, the headrest frame 110 may include a supporting portion 114. For example, the headrest frame 110 may include the supporting portion 114 for supporting the sound generating apparatus 150. For example, the supporting portion 114 may be configured to support a periphery of the sound generating apparatus 150. For example, the supporting portion 114 may be configured along an edge portion of the accommodating portion 113 to support an edge portion of the sound generating apparatus 150.

The sound generating apparatus 150 may be configured to include a piezoelectric material. The sound generating apparatus 150 may vibrate (or displace) based on a piezoelectric effect based on a driving signal to output (or generate) a sound (or a sound wave).

The sound generating apparatus 150 according to an embodiment of the present disclosure may include a vibration apparatus 151.

The vibration apparatus 151 may be between the accommodating portion 113 of the headrest frame 110 and the cushion member 130 and may be configured to output a sound. The vibration apparatus 151 may be accommodated into or supported by the accommodating portion 113 of the headrest frame 110 to output a sound. For example, the vibration apparatus 151 may be configured to be supported by the supporting portion 114 of the headrest frame 110. For example, the edge portion of the vibration apparatus 151 may be configured to be supported by the supporting portion 114.

The vibration apparatus 151 according to an embodiment of the present disclosure may be configured to include a piezoelectric material. The vibration apparatus 151 may vibrate (or displace) based on a piezoelectric effect based on the driving signal (or vibration driving signal or voice signal) to output (or generate) a sound (or a sound wave). For example, the vibration apparatus 151 may be a piezoelectric type vibration apparatus which includes the piezoelectric material. For example, the vibration apparatus 151 may include a piezoelectric material, and thus, may output a sound of a clear middle-high pitched sound band. For example, the vibration apparatus 151 may be configured to output a sound of about 200 Hz to about 20 kHz.

The vibration apparatus 151 according to an embodiment of the present disclosure may include a first vibration apparatus 151-1 and a second vibration apparatus 151-2.

The first vibration apparatus 151-1 may be accommodated into or supported by the first accommodating portion 113a of the headrest frame 110 to output a sound. The second vibration apparatus 151-2 may be accommodated into or supported by the second accommodating portion 113b of the headrest frame 110 to output a sound. For example, the supporting portion 114 of the headrest frame 110 may include a first supporting portion 114a for supporting the first vibration apparatus 151-1 and a second supporting portion 114b for supporting the second vibration apparatus 151-2. For example, the first supporting portion 114a may be configured along an edge portion of the first accommodating portion 113a and may be configured to support an edge portion of the first vibration apparatus 151-1. For example, the second supporting portion 114b may be configured along an edge portion of the second accommodating portion 113b and may be configured to support an edge portion of the second vibration apparatus 151-2.

According to an embodiment of the present disclosure, the first vibration apparatus 151-1 and the second vibration apparatus 151-2 may be configured to output different sounds. For example, the first vibration apparatus 151-1 may be configured to output a first sound (or a right channel sound). The second vibration apparatus 151-2 may be configured to output a second sound (or a left channel sound). Therefore, the sound generating apparatus 150 or the vibration apparatus 151 may generate (or output) a 2-channel stereo sound which includes the first sound based on the first vibration apparatus 151-1 and the second sound based on the second vibration apparatus 151-2.

Referring to FIGS. 3 to 5, each of the first vibration apparatus 151-1 and the second vibration apparatus 151-2 according to an embodiment of the present disclosure may include a vibration member 151a and a vibration element 151b.

The vibration member 151a may output a sound (or a sound wave) based on a vibration (or displacement) of the vibration element 151b. For example, the vibration member 151a may be a diaphragm, a vibration plate, a vibration substrate, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 151a may include a single nonmetal material or a composite nonmetal material, but embodiments of the present disclosure are not limited thereto. For example, the single nonmetal material or the composite nonmetal material of the vibration member 151a may include one or more of wood, rubber, plastic, carbon, glass, fiber, cloth, paper, mirror, and leather, but embodiments of the present disclosure are not limited thereto. For example, the paper may be cone paper for speakers. For example, the cone paper may be pulp or foamed plastic, or the like, but embodiments of the present disclosure are not limited thereto.

The vibration member 151a according to an embodiment of the present disclosure may be configured in a plastic material such as plastic or styrene material, but embodiments of the present disclosure are not limited thereto.

The plastic material of the vibration member 151a may be configured in polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but embodiments of the present disclosure are not limited thereto.

The material of the vibration member 151a may be an ABS material. The ABS material may be acrylonitrile, butadiene, and styrene.

The vibration member 151a according to another embodiment of the present disclosure may be configured in a porous material. For example, the vibration member 151a may include a micro cellular plastic material. For example, the vibration member 151a may be configured in a polyethylene terephthalate material or a polycarbonate material, but embodiments of the present disclosure are not limited thereto. For example, the vibration member 151a may be configured in a Micro Cellular polyethylene terephthalate (MCPET) material. The vibration member 151a configured in the MCPET may have high capability for original sound reproduction because having a low density and an excellent elastic force, thereby enhancing the quality of a sound.

The coupling member 153 may be disposed (or interposed) between the headrest frame 110 and the vibration member 151a. For example, the coupling member 153 may be disposed (or interposed) between the supporting portion 114 of the headrest frame 110 and the vibration member 151a. For example, the coupling member 153 may be disposed (or interposed) between the supporting portion 114 of the headrest frame 110 and a rear edge portion of the vibration member 151a.

The vibration member 151a may be accommodated into the accommodating portion 113 of the headrest frame 110 and may be connected or coupled to the supporting portion 114 of the headrest frame 110 by using the coupling member 153. For example, an edge portion of the vibration member 151a may be connected or coupled to the supporting portion 114 of the headrest frame 110 by using the coupling member 153. The vibration member 151a may be spaced apart from a bottom surface of the accommodating portion 113. For example, a center portion, except an edge portion, of the vibration member 151a may be spaced apart from the bottom surface of the accommodating portion 113. The vibration member 151a may be configured at the accommodating portion 113. For example, the vibration member 151a may be configured to cover the accommodating portion 113. For example, the vibration member 151a may have a same shape as that of the accommodating portion 113 and may have a size which is greater than that of the accommodating portion 113, so as to cover the accommodating portion 113, but embodiments of the present disclosure are not limited thereto.

In the first vibration apparatus 151-1, the vibration member 151a may be accommodated into the first accommodating portion 113a and may be connected or coupled to the first supporting portion 114a of the supporting portion 114 by using a first coupling member 153a of the coupling member 153. For example, the edge portion of the vibration member 151a may be connected or coupled to the first supporting portion 114a by using the first coupling member 153a. For example, the center portion, except the edge portion, of the vibration member 151a may be spaced apart from a bottom surface of the first accommodating portion 113a. The vibration member 151a may be configured on the first accommodating portion 113a. For example, the vibration member 151a may be configured to cover the first accommodating portion 113a. For example, the vibration member 151a may have a same shape as that of the first accommodating portion 113a and may have a size which is greater than that of the first accommodating portion 113a, so as to cover the first accommodating portion 113a, but embodiments of the present disclosure are not limited thereto.

In the second vibration apparatus 151-2, the vibration member 151a may be accommodated into the second accommodating portion 113b and may be connected or coupled to the second supporting portion 114b of the supporting portion 114 by using a second coupling member 153b of the coupling member 153. For example, the edge portion of the vibration member 151a may be connected or coupled to the second supporting portion 114b by using the second coupling member 153b. For example, the center portion, except the edge portion, of the vibration member 151a may be spaced apart from a bottom surface of the second accommodating portion 113b. The vibration member 151a may be configured on the second accommodating portion 113b. For example, the vibration member 151a may be configured to cover the second accommodating portion 113b. For example, the vibration member 151a may have a same shape as that of the second accommodating portion 113b and may have a size which is greater than that of the second accommodating portion 113b, so as to cover the second accommodating portion 113b, but embodiments of the present disclosure are not limited thereto.

The vibration element 151b may be configured to vibrate (or displace) the vibration member 151a. For example, the vibration element 151b may be configured to vibrate (or displace or driven) the vibration member 151a by a vibration (or displacement or driving) based on the driving signal (or vibration driving signal or voice signal). For example, the vibration element 151b may output (or generate) a sound by using the vibration member 151a as a vibration plate. For example, the vibration element 151b may include a piezoelectric type vibration element which include a piezoelectric effect. For example, the vibration element 151b may be a vibration generating device, a vibration film, a vibration generating film, a vibrator, an active vibrator, an active vibration generator, an actuator, an exciter, a film actuator, a film exciter, an ultrasonic actuator, or an active vibration member, or the like, but embodiments of the present disclosure are not limited thereto.

The vibration element 151b may be disposed (or connected to) or configured on the accommodating portion 113 of the headrest frame 110 to vibrate (or displace) the vibration member 151a. The vibration element 151b may be disposed (or connected to) or configured at the vibration member 151a. For example, the vibration element 151b may be disposed (or connected to) or configured at one or more of a first surface and a second surface, which is opposite to the first surface, of the vibration member 151a. As an embodiment of the present disclosure, the vibration element 151b may be disposed (or connected to) or configured at the first surface of the vibration member 151a. As another embodiment of the present disclosure, the vibration element 151b may be disposed (or connected to) or configured at the second surface of the vibration member 151a. As another embodiment of the present disclosure, the vibration element 151b may be disposed (or connected to) or configured at each of the first surface and the second surface of the vibration member 151a. For example, the vibration element 151b may have a bimorph structure disposed with the vibration member 151a therebetween.

Referring to FIGS. 3 to 5, each of the first vibration apparatus 151-1 and the second vibration apparatus 151-2 according to an embodiment of the present disclosure may further include an adhesive member 151c. For example, the vibration element 151b may be connected (or coupled) to the vibration member 151a by using the adhesive member 151c.

In the first vibration apparatus 151-1, the vibration element 151b may be connected or coupled to one or more of a first surface and a second surface, which is opposite to the first surface, of the vibration member 151a by using the adhesive member 151c. For example, the vibration element 151b may be connected (or coupled) to a rear surface of the vibration member 151a by using the adhesive member 151c and may be spaced apart from a bottom surface of the first accommodating portion 113a of the accommodating portion 113. For example, the vibration element 151b of the first vibration apparatus 151-1 may vibrate the vibration member 151a to output the first sound (or right channel sound). The vibration member 151a of the first vibration apparatus 151-1 may vibrate based on a vibration (or displacement or driving) of the vibration element 151b to output (or generate) the first sound.

In the second vibration apparatus 151-2, the vibration element 151b may be connected or coupled to one or more of the first surface and the second surface, which is opposite to the first surface, of the vibration member 151a by using the adhesive member 151c. For example, the vibration element 151b may be connected (or coupled) to the rear surface of the vibration member 151a by using the adhesive member 151c and may be spaced apart from a bottom surface of the second accommodating portion 113b of the accommodating portion 113. For example, the vibration element 151b of the second vibration apparatus 151-2 may vibrate the vibration member 151a to output the second sound (or left channel sound). The vibration member 151a of the second vibration apparatus 151-2 may vibrate based on a vibration (or displacement or driving) of the vibration element 151b to output (or generate) the second sound.

Referring to FIGS. 3 to 5, the sound generating apparatus 150 according to an embodiment of the present disclosure may further include a cover 155.

The cover 155 may be configured to absorb an impact applied to the headrest frame 110 and/or the vibration apparatus 151. The cover 155 may be configured at the vibration apparatus 151 or the vibration element 151b of the vibration apparatus 151. For example, the cover 155 may be configured to cover the vibration apparatus 151 or the vibration element 151b of the vibration apparatus 151. The cover 155 may be configured at a front surface of the headrest frame 110 and a front surface of the vibration apparatus 151. For example, the cover 155 may be configured to cover the front surface of the headrest frame 110 and the front surface of the vibration apparatus 151. The cover 155 may be configured at the protrusion portion 112 of the headrest frame 110 and the first vibration apparatus 151-1 and the second vibration apparatus 151-2 of the vibration apparatus 151. For example, the cover 155 may be configured to cover the protrusion portion 112 of the headrest frame 110 and the first vibration apparatus 151-1 and the second vibration apparatus 151-2 of the vibration apparatus 151.

Although it is described with reference to FIGS. 1-5 that the base frame 111 and the cover 155 are separated member, the present is not limited to it. For example, the base frame 111 and the cover 155 may be integrally formed as an enclosure. The enclosure may have the accommodating portion 113 and include an opening front portion.

The cover 155 according to an embodiment of the present disclosure may be between the headrest frame 110 and the cushion member 130. For example, the cover 155 may be disposed or configured between the front surface of the headrest frame 110 and the cushion member 130 to cover the vibration apparatus 151. For example, the cover 155 may be disposed or configured between the front surface of the headrest frame 110 and the cushion member 130 to cover the first vibration apparatus 151-1 and the second vibration apparatus 151-2 of the vibration apparatus 151.

The cover 155 according to an embodiment of the present disclosure may be configured to have ae same size and shape as those of the headrest frame 110 and/or the cushion member 130, but embodiments of the present disclosure are not limited thereto. For example, the cover 155, the headrest frame 110, and the cushion member 130 may be configured to have a same size and a same shape, but embodiments of the present disclosure are not limited thereto. For example, the cover 155 may include a material capable of absorbing an impact. For example, the cover 155 may include a foam material or a sponge material, but embodiments of the present disclosure are not limited thereto. For example, the cover 155 may be a cushion cover, a foam cover, a sponge cover, or a buffer cover, but embodiments of the present disclosure are not limited thereto.

The cover 155 according to an embodiment of the present disclosure may include a plate 155a and a sidewall 155b.

The plate 155a may be between the headrest frame 110 and the cushion member 130.

The plate 155a may be configured at the front surface of the headrest frame 110. For example, the plate 155a may be configured to cover the front surface of the headrest frame 110. The plate 155a may be disposed or configured between the front surface of the headrest frame 110 and the cushion member 130. For example, the plate 155a may be disposed or configured between the front surface of the headrest frame 110 and the cushion member 130 to cover the vibration apparatus 151. For example, the plate 155a may be configured to have a same size and a same shape as those of the headrest frame 110 and/or the cushion member 130, but embodiments of the present disclosure are not limited thereto. For example, the plate 155a may be a cushion plate, a foam plate, a sponge plate, or a buffer plate, but embodiments of the present disclosure are not limited thereto.

The sidewall 155b may be between the plate 155a and the headrest frame 110. The sidewall 155b may be connected to or configured at an edge portion of the plate 155a and an edge portion of the headrest frame 110. The sidewall 155b may be configured to provide a space between the plate 155a and the headrest frame 110. For example, the sidewall 155b may be a cover sidewall, a cushion sidewall, a foam sidewall, a sponge sidewall, or a buffer sidewall, but embodiments of the present disclosure are not limited thereto.

The cover 155 according to an embodiment of the present disclosure may include a sound emission portion 155h.

The sound emission portion 155h may be configured to overlap (or correspond to) the vibration apparatus 151. For example, the sound emission portion 155h may be a path through which a sound generated (or output) by the sound generating apparatus 150 or the vibration apparatus 151 is output to the outside (or cushion member 130). For example, the sound emission portion 155h may be configured to pass through the cover 155 along a thickness direction Z of the cover 155. For example, the sound emission portion 155h may be configured to pass through the plate 155a along the thickness direction Z of the cover 155.

The cover 155 according to an embodiment of the present disclosure may include a first sound emission portion 155h1 and a second sound emission portion 155h2.

The first sound emission portion 155h1 may overlap (or correspond) the first vibration apparatus 151-1 or the vibration element 151b of the first vibration apparatus 151-1. The first sound emission portion 155h1 may be a path through which a sound generated (or output) by the first vibration apparatus 151-1 is output to the outside (or cushion member 130). For example, the first sound emission portion 155h1 may be configured to pass through (or vertically pass through) a first region of the cover 155 overlapping (or corresponding to) the first vibration apparatus 151-1 along the thickness direction Z of the cover 155. For example, the first sound emission portion 155h1 may be configured to pass through (or vertically pass through) the first region of the plate 155a overlapping (or corresponding to) the first vibration apparatus 151-1 along the thickness direction Z of the cover 155.

The second sound emission portion 155h2 may overlap (or correspond) the second vibration apparatus 151-2 or the vibration element 151b of the second vibration apparatus 151-2. The second sound emission portion 155h2 may be a path through which a sound generated (or output) by the second vibration apparatus 151-2 is output to the outside (or cushion member 130). For example, the second sound emission portion 155h2 may be configured to pass through (or vertically pass through) a second region of the cover 155 overlapping (or corresponding to) the second vibration apparatus 151-2 along the thickness direction Z of the cover 155. For example, the second sound emission portion 155h1 may be configured to pass through (or vertically pass through) the second region of the plate 155a overlapping (or corresponding to) the second vibration apparatus 151-2 along the thickness direction Z of the cover 155.

Each of the first sound emission portion 155h1 and the second sound emission portion 155h2 according to an embodiment of the present disclosure may be configured to include one or more holes (or sound holes or sound emission holes).

Each of the first sound emission portion 155h1 and the second sound emission portion 155h2 according to another embodiment of the present disclosure may be configured to include one or more holes (or sound holes or sound emission holes) based on a mesh structure 155m.

Referring to FIGS. 1 and 2, the sheath member 190 may be an outermost member which is configured to surround the headrest 10. The sheath member 190 may be configured at a rear surface 111r and a lateral surface of the headrest frame 110 and a front surface and a lateral surface of the cushion member 130. For example, the sheath member 190 may be configured to cover a rear surface 111r and a lateral surface of the headrest frame 110 and a front surface and a lateral surface of the cushion member 130. The sheath member 190 may be configured at the rear surface 111r and the lateral surface of the headrest frame 110, a lateral surface of the sound generating apparatus 150, and the front surface and the lateral surface of the cushion member 130. For example, the sheath member 190 may be configured to cover the rear surface 111r and the lateral surface of the headrest frame 110, the lateral surface of the sound generating apparatus 150, and the front surface and the lateral surface of the cushion member 130. The sheath member 190 may be configured at the rear surface 111r and the lateral surface of the headrest frame 110, a lateral surface of the cover 155 of the sound generating apparatus 150, and the front surface and the lateral surface of the cushion member 130. For example, the sheath member 190 may be configured to cover the rear surface 111r and the lateral surface of the headrest frame 110, the lateral surface of the cover 155 of the sound generating apparatus 150, and the front surface and the lateral surface of the cushion member 130.

The sheath member 190 may be a fiber material or a leather material, but embodiments of the present disclosure are not limited thereto. For example, the sheath member 190 of the fiber material may include at least one of a synthetic fiber, a carbon fiber (or an aramid fiber), and a natural fiber, but embodiments of the present disclosure are not limited thereto. For example, the sheath member 190 of the fiber material may be a textile sheet, a knit sheet, or a nonwoven fabric, but embodiments of the present disclosure are not limited thereto. For example, the sheath member 190 of the fiber material may be a fabric member, but embodiments of the present disclosure are not limited thereto.

The synthetic fiber may be a thermoplastic resin and may include a polyolefin-based fiber which is an eco-friendly material which does not relatively release a harmful substance. For example, the polyolefin-based fiber may include a polyethylene fiber, a polypropylene fiber, or a polyethylene terephthalate fiber, but embodiments of the present disclosure are not limited thereto. The polyolefin-based fiber may be a fiber of a single resin or a fiber of a core-shell structure, but embodiments of the present disclosure are not limited thereto. The natural fiber may be a composite fiber of one or two or more of a jute fiber, a kenaf fiber, an abaca fiber, a coconut fiber, and a wood fiber, but embodiments of the present disclosure are not limited thereto.

The sheath member 190 of the leather material may include natural leather or artificial leather, but embodiments of the present disclosure are not limited thereto.

Referring to FIGS. 2 to 5, the headrest 10 according to an embodiment of the present disclosure may further include a cushion pad 170.

The cushion pad 170 may be accommodated into the cushion member 130. For example, the cushion pad 170 may be between the sheath member 190 and the cushion member 130. For example, the cushion pad 170 may be between the hollow portion 131 of the cushion member 130 and the sheath member 190. For example, the cushion pad 170 may be accommodated into the hollow portion 131 and may be covered by the sheath member 190. For example, the cushion pad 170 may include a shape capable of being accommodated into the hollow portion 131.

According to an embodiment of the present disclosure, the cushion pad 170 may be a path through which a sound generated (or output) by the vibration apparatus 151 is output. The cushion pad 170 may be accommodated into the hollow portion 131 of the cushion member 130 and may be configured (or disposed) to cover the sound emission portion 155h of the sound generating apparatus 150. The cushion pad 170 may be accommodated into the hollow portion 131 of the cushion member 130 and may be supported by the cover 155 of the sound generating apparatus 150. A rear surface of the cushion pad 170 may be supported by the mesh structure 155m in the sound emission portion 155h.

According to an embodiment of the present disclosure, a sound generated by the sound generating apparatus 150 or the vibration apparatus 151 may be output to the outside through the sound emission portion 155h of the cover 155 and the cushion pad 170.

The cushion pad 170 according to an embodiment of the present disclosure may include a first cushion pad 171 and a second cushion pad 172.

The first cushion pad 171 may be accommodated into the first hollow portion 131a of the cushion member 130. For example, the first cushion pad 171 may be between the first hollow portion 131a and the sheath member 190. For example, the first cushion pad 171 may be accommodated into the first hollow portion 131a and may be covered by the sheath member 190. For example, the first cushion pad 171 may include a shape capable of being accommodated into the first hollow portion 131a.

According to an embodiment of the present disclosure, the first cushion pad 171 may be a path through which a sound generated (or output) by the first vibration apparatus 151-1 is output. The first cushion pad 171 may be accommodated into the first hollow portion 131a of the cushion member 130 and may be configured (or disposed) to cover the first sound emission portion 155h1 of the sound generating apparatus 150. For example, the first cushion pad 171 may be accommodated into the first hollow portion 131a and may be configured (or disposed) to cover the first sound emission portion 155h1 of the cover 155 of the sound generating apparatus 150. A rear surface of the first cushion pad 171 may be supported by the mesh structure 155m in the first sound emission portion 155h1.

The second cushion pad 172 may be accommodated into the second hollow portion 131b of the cushion member 130. For example, the second cushion pad 172 may be between the second hollow portion 131b and the sheath member 190. For example, the second cushion pad 172 may be accommodated into the second hollow portion 131b and may be covered by the sheath member 190. For example, the second cushion pad 172 may include a shape capable of being accommodated into the second hollow portion 131b.

According to an embodiment of the present disclosure, the second cushion pad 172 may be a path through which a sound generated (or output) by the second vibration apparatus 151-2 is output. The second cushion pad 172 may be accommodated into the second hollow portion 131b of the cushion member 130 and may be configured (or disposed) to cover the second sound emission portion 155h2 of the sound generating apparatus 150. For example, the second cushion pad 172 may be accommodated into the second hollow portion 131b and may be configured (or disposed) to cover the second sound emission portion 155h2 of the cover 155 of the sound generating apparatus 150. A rear surface of the second cushion pad 172 may be supported by the mesh structure 155m in the second sound emission portion 155h2.

The cushion pad 170 (or first cushion pad 171 or second cushion pad 172) may include a material which may output a sound and may absorb an impact. For example, the cushion pad 170 (or first cushion pad 171 or second cushion pad 172) may include a foam material or a sponge material, but embodiments of the present disclosure are not limited thereto.

The cushion pad 170 (or first cushion pad 171 or second cushion pad 172) according to another embodiment of the present disclosure may include a porous material, but embodiments of the present disclosure are not limited thereto. For example, the cushion pad 170 (or first cushion pad 171 or second cushion pad 172) may include a porous material including a plurality of porous holes 170h. For example, the plurality of porous holes 170h may be configured regularly or irregularly. For example, the cushion pad 170 may include an air mesh material. For example, the cushion pad 170 may include the plurality of porous holes (or sound through hole) 170h and a cushion layer having a mesh material.

Referring to FIGS. 3 to 5, the headrest 10 according to an embodiment of the present disclosure may further include a sound blocking member 180.

The sound blocking member 180 may be configured to block a sound which is output in a rearward direction of the headrest frame 110. For example, the sound blocking member 180 may be between the headrest frame 110 and the sheath member 190. For example, the sound blocking member 180 may be between the rear surface 111r of the headrest frame 110 and the sheath member 190. The sound blocking member 180 may be disposed (or configured) at or connected (or coupled) to the rear surface 111r of the headrest frame 110 and may be covered by the sheath member 190. For example, the sound blocking member 180 may be connected (or coupled) or attached to the rear surface 111r of the headrest frame 110 and may be covered by the sheath member 190.

The sound blocking member 180 may include a material for blocking or absorbing a sound. For example, the sound blocking member 180 may include rubber, but embodiments of the present disclosure are not limited thereto. For example, the sound blocking member 180 may be ethylene propylene rubber or urethane rubber, but embodiments of the present disclosure are not limited thereto. For example, the ethylene propylene rubber may be ethylene propylene diene monomer (EPDM), but embodiments of the present disclosure are not limited thereto.

The headrest 10 according to an embodiment of the present disclosure may include the sound generating apparatus 150 or the vibration apparatus 151, and thus, may output a sound which is generated based on a vibration (or displacement or driving) of the sound generating apparatus 150 or the vibration apparatus 151. For example, the headrest 10 may output a 2-channel stereo sound including a left channel sound and a right channel sound generated based on a vibration (or displacement or driving) of the first vibration apparatus 151-1 and the second vibration apparatus 151-2 of the vibration apparatus 151. For example, the headrest 10 according to an embodiment of the present disclosure may output a sound which is generated based on a vibration (or displacement or driving) of the sound generating apparatus 150 or the vibration apparatus 151 which includes the piezoelectric material, and thus, may output a sound of a clear middle-high pitched sound band. For example, the headrest 10 according to an embodiment of the present disclosure may be configured to output a sound of about 200 Hz to about 20 kHz.

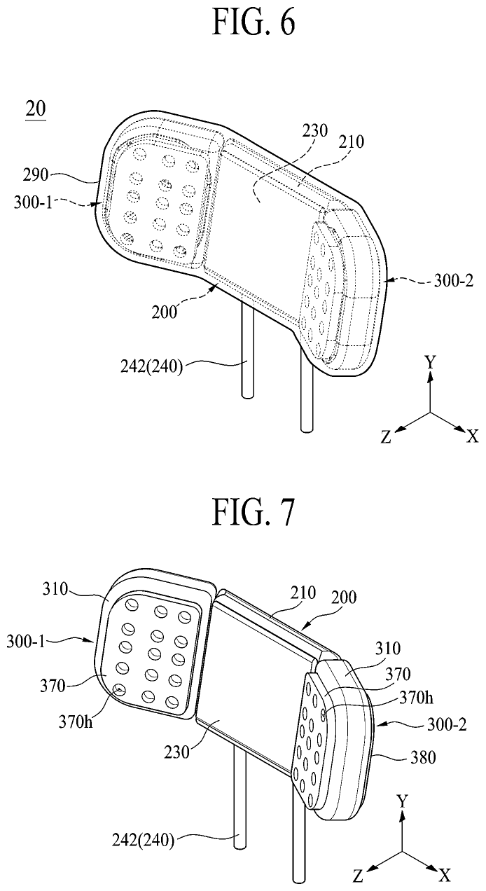

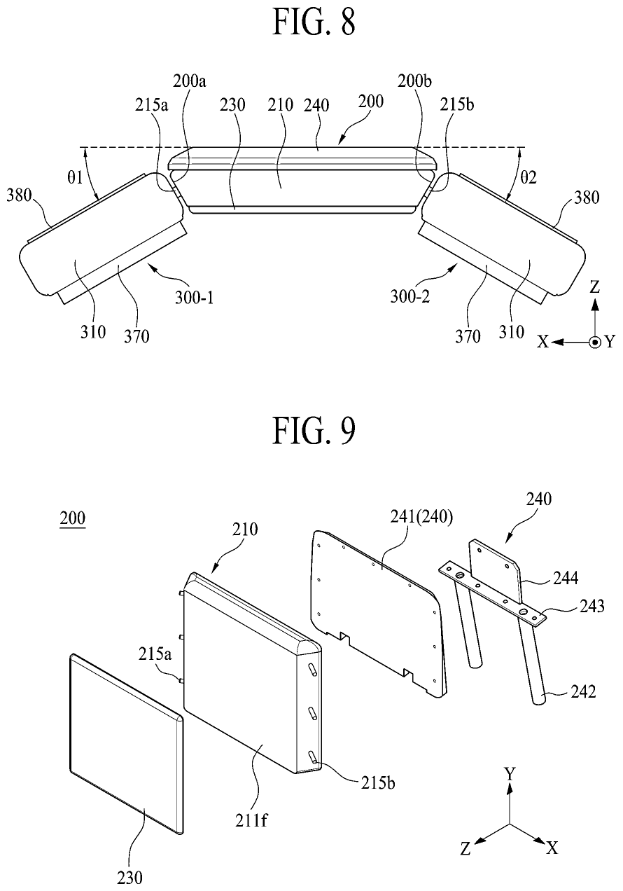

FIG. 6 is a perspective view illustrating a headrest according to another embodiment of the present disclosure. FIG. 7 is a perspective view illustrating an embodiment where the sheath member on the headrest illustrated in FIG. 6 has been removed. FIG. 8 is a plan view illustrating a headrest according to another embodiment of the present disclosure.

Referring to FIGS. 6 and 7, the headrest 20 according to another embodiment of the present disclosure may be configured to output a sound. For example, the headrest 20 may be configured to output a left channel sound and a right channel sound. For example, the headrest 20 may be configured to output a 2-channel stereo sound including the left channel sound and the right channel sound. For example, the headrest 20 may be a headrest apparatus, a headrest speaker, a headrest speaker apparatus, a headrest for chair, a headrest speaker for chair, a headrest speaker apparatus for chair, a headrest for vehicular apparatus, a headrest speaker for vehicular apparatus, or a headrest speaker apparatus for vehicular apparatus, but embodiments of the present disclosure are not limited thereto.

The headrest 20 according to another embodiment of the present disclosure may include a first sound generating apparatus 300-1, a second sound generating apparatuses 300-2, and a sheath member 290.

The headrest part 200 may be configured to absorb an impact. For example, the headrest part 200 may include a tetragonal shape or a tetragonal shape including a curved portion, but embodiments of the present disclosure are not limited thereto. For example, the headrest part 200 may be configured to accommodate a driving circuit part for driving the first sound generating apparatus 300-1 and the second sound generating apparatus 300-2.

The first sound generating apparatus 300-1 may be at a first side 200a of the headrest part 200. The first sound generating apparatus 300-1 may be configured to be connected (or supported) or fixed (or coupled) to the first side 200a of the headrest part 200. For example, the first sound generating apparatus 300-1 may be configured to be connected (or supported) or fixed (or coupled) to the first side 200a of the headrest part 200 by one or more first connection members 215a. For example, the first side 200a of the headrest part 200 may be a first lateral surface, a first sidewall, a first short side, a left surface, a left sidewall, or a left short side, but embodiments of the present disclosure are not limited thereto.

The first sound generating apparatus 300-1 according to an embodiment of the present disclosure may be configured to tilt (or rotate) from the first side 200a of the headrest part 200. For example, the first sound generating apparatus 300-1 may be configured to tilt (or rotate) at a predetermined first angle (01) from the first side 200a of the headrest part 200. For example, a length direction of the headrest part 200 may intersect with a length direction of the first sound generating apparatus 300-1. For example, when the length direction of the headrest part 200 is parallel to a first direction X or an X-axis direction X, the length direction of the first sound generating apparatus 300-1 may intersect with the first direction X or the X-axis direction X. For example, as illustrated in FIG. 8, with respect to the length direction of the headrest part 200 and the length direction of the first sound generating apparatus 300-1, the first angle (01) between the headrest part 200 and the first sound generating apparatus 300-1 may be an acute angle, and for example, may be 30 degrees, but embodiments of the present disclosure are not limited thereto.

The first sound generating apparatus 300-1 may be configured to include a piezoelectric material. The first sound generating apparatus 300-1 may vibrate (or displace) based on a piezoelectric effect based on a driving signal to output (or generate) a sound (or a sound wave).

The second sound generating apparatus 300-2 may be at the second surface 200b, which is opposite to the first side 200a of the headrest part 200. The second sound generating apparatus 300-2 may be configured to be connected (or supported) or fixed (or coupled) to the second side 200b of the headrest part 200. For example, the second sound generating apparatus 300-2 may be configured to be connected (or supported) or fixed (or coupled) to the second side 200b of the headrest part 200 by one or more second connection members 215b. For example, the second side 200b of the headrest part 200 may be a second lateral surface, a second sidewall, a second short side, a right surface, a right sidewall, or a right short side, but embodiments of the present disclosure are not limited thereto.

The second sound generating apparatus 300-2 according to an embodiment of the present disclosure may be configured to tilt (or rotate) from the second side 200b of the headrest part 200. For example, the second sound generating apparatus 300-2 may be configured to tilt (or rotate) at a predetermined second angle (θ2) from the second side 200b of the headrest part 200. For example, a length direction of the headrest part 200 may intersect with a length direction of the second sound generating apparatus 300-2. For example, when the length direction of the headrest part 200 is parallel to the first direction X or the X-axis direction X, the length direction of the first sound generating apparatus 300-1 may intersect with the first direction X or the X-axis direction X. For example, as illustrated in FIG. 8, with respect to the length direction of the headrest part 200 and the length direction of the second sound generating apparatus 300-2, the second angle (θ2) between the headrest part 200 and the second sound generating apparatus 300-2 may be an acute angle. For example, the second angle (θ2) between the headrest part 200 and the second sound generating apparatus 300-2 may be a same as or different from the first angle (θ1) between the headrest part 200 and the first sound generating apparatus 300-1. For example, the second angle (θ2) between the headrest part 200 and the second sound generating apparatus 300-2 may be 30 degrees, but embodiments of the present disclosure are not limited thereto.

According to an embodiment of the present disclosure, the first sound generating apparatus 300-1 and the second sound generating apparatus 300-2 may be disposed in different directions with the headrest part 200 therebetween. For example, each of the first sound generating apparatus 300-1 and the second sound generating apparatus 300-2 may be disposed to face an arbitrary virtual point in a forward direction of the headrest part 200. For example, a distance (or shortest distance) between the arbitrary virtual point and the first sound generating apparatus 300-1 may be equal to a distance (or shortest distance) between the arbitrary virtual point and the second sound generating apparatus 300-2, but embodiments of the present disclosure are not limited thereto. For example, each of the first sound generating apparatus 300-1 and the second sound generating apparatus 300-2 may have a symmetric structure with respect to the headrest part 200, but embodiments of the present disclosure are not limited thereto.

According to another embodiment of the present disclosure, each of the first sound generating apparatus 300-1 and the second sound generating apparatus 300-2 may have an asymmetric structure with respect to the headrest part 200. For example, the first angle (θ1) between the headrest part 200 and the first sound generating apparatus 300-1 may be different from the second angle (θ2) between the headrest part 200 and the second sound generating apparatus 300-2. For example, the distance (or shortest distance) between the arbitrary virtual point and the first sound generating apparatus 300-1 may be different from the distance (or shortest distance) between the arbitrary virtual point and the second sound generating apparatus 300-2.

The second sound generating apparatus 300-2 may be configured to include a piezoelectric material. The second sound generating apparatus 300-2 may vibrate (or displace) based on a piezoelectric effect based on a driving signal to output (or generate) a sound (or a sound wave).

According to an embodiment of the present disclosure, the first sound generating apparatus 300-1 may be configured to output the first sound (or right channel sound). The second sound generating apparatus 300-2 may be configured to output the second sound (or left channel sound). Therefore, the headrest 20 according to another embodiment of the present disclosure may generate (or output) a 2-channel stereo sound which includes a first sound based on the first sound generating apparatus 300-1 and a second sound based on the second sound generating apparatus 300-2.

The sheath member 190 may be an outermost member which is configured to surround the headrest 20. For example, the sheath member 190 may be configured to surround the headrest part 200, the first sound generating apparatus 300-1, and the second sound generating apparatus 300-2. For example, the sheath member 190 may be a fiber material or a leather material. For example, the sheath member 190 may be a same or substantially a same as that of the sheath member 190 described above with reference to FIG. 1, and thus, repeated descriptions thereof are omitted.

The headrest 20 according to another embodiment of the present disclosure may include the first sound generating apparatus 300-1 and the second sound generating apparatus 300-2, and thus, may output the first sound based on the first sound generating apparatus 300-1 and the second sound based on the second sound generating apparatus 300-2. For example, the headrest 20 may output a 2-channel stereo sound which includes the right channel sound and the left channel sound based on a vibration (or displacement or driving) of the first sound generating apparatus 300-1 and the second sound generating apparatus 300-2. For example, the headrest 20 according to another embodiment of the present disclosure may output the first sound (or right channel sound) and the second sound (or left channel sound) of a clear middle-high pitched sound band generated based on a vibration (or displacement or driving) of the first sound generating apparatus 300-1 and the second sound generating apparatus 300-2 including a piezoelectric material. For example, the headrest 10 according to another embodiment of the present disclosure may output the first sound and the second sound of about 200 Hz to about 20 KHz.

FIG. 9 is an exploded perspective view illustrating the headrest part illustrated in FIGS. 6 to 8 according to an embodiment of the present disclosure.

Referring to FIGS. 8 and 9, the headrest part 200 according to an embodiment of the present disclosure may include a headrest frame 210 and a cushion member 230.

The headrest part 200 or the headrest frame 210 may be a body of the headrest 10, a main structure, a housing, or an enclosure, but embodiments of the present disclosure are not limited thereto. For example, the headrest part 200 or the headrest frame 210 may include a tetragonal shape or a tetragonal shape including a curved portion, but embodiments of the present disclosure are not limited thereto.

The headrest part 200 or the headrest frame 210 according to an embodiment of the present disclosure may be configured in a plastic material such as plastic or styrene material, but embodiments of the present disclosure are not limited thereto. For example, a material of the headrest part 200 or the headrest frame 210 may be the same or substantially the same as that of the headrest part 100 or the headrest frame 110 described above with reference to FIGS. 1 to 5, and thus, its repeated descriptions are omitted.

The headrest frame 210 according to an embodiment of the present disclosure may be configured to accommodate a driving circuit part for driving the first sound generating apparatus 300-1 and the second sound generating apparatus 300-2.

The cushion member 230 may be at a front surface 211f of the headrest frame 210. For example, the cushion member 230 may be configured to cover the front surface 211f of the headrest frame 210. For example, the cushion member 230 may be configured to have ae same size and shape as those of the headrest frame 210, but embodiments of the present disclosure are not limited thereto. For example, the cushion member 230 may include a material which absorbs an impact.

The cushion member 230 according to an embodiment of the present disclosure may include a foam material or a sponge material, but embodiments of the present disclosure are not limited thereto.

The cushion member 230 according to another embodiment of the present disclosure may include a porous material, but embodiments of the present disclosure are not limited thereto. For example, the cushion member 230 may include a porous material including a plurality of porous holes. For example, the plurality of porous holes may be configured regularly or irregularly. For example, the cushion member 230 may include an air mesh material, but embodiments of the present disclosure are not limited thereto. For example, the cushion member 230 may include the plurality of porous holes (or sound through hole) and a cushion layer having a mesh material.

The headrest part 200 according to an embodiment of the present disclosure may further include a support rod part 240.

The support rod part 240 according to an embodiment of the present disclosure may be configured to be connected (or coupled) to a lower surface of the headrest part 200 or the headrest frame 210, or may be configured to support the lower surface of the headrest part 200 or the headrest frame 210. For example, the support rod part 240 may include one or more support rods 242.

The one or more support rods 242 may be configured to be connected to the lower surface of the headrest part 200 or the headrest frame 210. For example, the support rod part 240 may include a pair of support rods 242. For example, the one or more support rods 242 may be connected to an upper portion of a seatback of a seat for vehicle or a backrest frame of a chair.

The support rod part 240 according to another embodiment of the present disclosure may be configured to be connected (or coupled) to a rear surface of the headrest part 200 or the headrest frame 210, or may be configured to support the rear surface of the headrest part 200 or the headrest frame 210.

The support rod part 240 according to another embodiment of the present disclosure may include a support frame 241 and one or more support rods 242.

The support frame 241 may be configured to be connected (or coupled) to the rear surface of the headrest part 200 or the headrest frame 210, or may be configured to support the rear surface of the headrest part 200 or the headrest frame 210. The support frame 241 may be configured to cover the rear surface of the headrest part 200 or the headrest frame 210.

The one or more support rods 242 may be configured to be connected to a lower surface and a rear surface of the headrest frame 210. For example, the support rod part 240 may include a pair of support rods 242, but embodiments of the present disclosure are not limited thereto. For example, the one or more (or a pair of) support rods 242 may be connected to an upper portion of a seatback of a seat for vehicle or a backrest frame of a chair.

The support rod part 240 according to another embodiment of the present disclosure may further include a first support plate 243 and a second support plate 244.

The first support plate 243 may be connected to the support frame 241 and may be configured to support the one or more (or pair of) support rods 242. For example, the first support plate 243 may be connected (or coupled) to the lower surface of the support frame 241 and may be configured to support the one or more (or a pair of) support rods 242 in common.

According to an embodiment of the present disclosure, the one or more (or pair of) support rods 242 may be connected (or coupled) to the first support plate 243 by a first fastening member. For example, the first fastening member may be fastened to an upper surface of each of the one or more (or pair of) support rods 242 through the first support plate 243. For example, each of a plurality of first fastening members may be a screw or a bolt, but embodiments of the present disclosure are not limited thereto.

According to an embodiment of the present disclosure, the first support plate 243 may be connected (or coupled) to a lower surface of the support frame 241 by a plurality of second fastening members. For example, the plurality of second fastening members may be fastened to the lower surface of support frame 241 through the first support plate 243. For example, each of the plurality of second fastening members may be a screw or a bolt, but embodiments of the present disclosure are not limited thereto.

The second support plate 244 may be connected (or coupled) to the rear surface of the support frame 241. For example, the second support plate 244 may be connected (or coupled) to one side of the first support plate 243 and may be connected (or coupled) to the rear surface of the support frame 241. For example, the second support plate 244 may protrude or vertically protrude from one side of the first support plate 243, but embodiments of the present disclosure are not limited thereto. For example, the second support plate 244 may be provided (or integrated) as one body with the first support plate 243.

According to an embodiment of the present disclosure, the second support plate 244 may be connected (or coupled) to the rear surface of the support frame 241 by a plurality of third fastening members. For example, the plurality of third fastening members may be fastened to the rear surface of support frame 241 through the second support plate 244. For example, each of the plurality of third fastening members may be a screw or a bolt, but embodiments of the present disclosure are not limited thereto.

The headrest part 200 according to an embodiment of the present disclosure may further include one or more first connection members 215a and one or more second connection members 215b.

The one or more first connection members 215a may protrude to have a predetermined length from a first side 200a of the headrest frame 210 or the headrest part 200. The one or more first connection members 215a may be configured to tilt (or rotate) at a predetermined first angle (θ1) from the first side 200a of the headrest frame 210 or the headrest part 200. The one or more first connection members 215a may be connected to one surface of the first sound generating apparatus 300-1. For example, an end portion of each of the one or more first connection members 215a may be inserted into the one surface of the first sound generating apparatus 300-1.

The one or more second connection members 215b may protrude to have a predetermined length from a second side 200b of the headrest frame 210 or the headrest part 200. The one or more second connection members 215b may be configured to tilt (or rotate) at a predetermined second angle (θ2) from the second side 200b of the headrest frame 210 or the headrest part 200. The one or more second connection members 215b may be connected to one surface of the second sound generating apparatus 300-2. For example, an end portion (or one side) of each of the one or more second connection members 215b may be inserted into the one surface of the second sound generating apparatus 300-2.

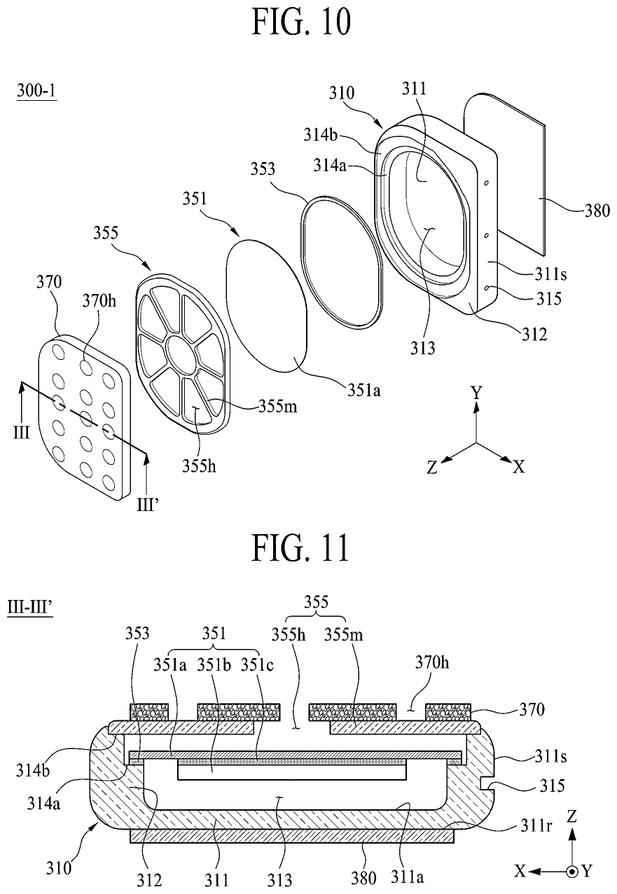

FIG. 10 is an exploded perspective view illustrating a first sound generating apparatus illustrated in FIGS. 6 to 8 according to an embodiment of the present disclosure. FIG. 11 is a cross-sectional view taken along line III-III′ illustrated in FIG. 10.

Referring to FIGS. 8, 10, and 11, a first sound generating apparatus 300-1 according to an embodiment of the present disclosure may include an enclosure 310, a vibration apparatus 351, and a cushion member 370.

The enclosure 310 may be at the first side 200a of the headrest part 200. The first sound generating apparatus 300-1 may be configured to be connected (or supported) or fixed (or coupled) to the first side 200a of the headrest part 200. For example, the enclosure 310 may be configured to support the vibration apparatus 351 and surround the vibration apparatus 351. The enclosure 310 may include a tetragonal shape or a tetragonal shape including a curved portion, but embodiments of the present disclosure are not limited thereto.

The enclosure 310 may be at the vibration apparatus 351. The enclosure 310 may be configured to support the vibration apparatus 351. For example, the enclosure 310 may be configured to support the vibration apparatus 351 and surround the vibration apparatus 351. For example, the enclosure 310 may be configured to accommodate (or receive) the vibration apparatus 351. For example, the enclosure 310 may be a housing, a case, a case member, a housing member, a cabinet, a sound box, or the like, but embodiments of the present disclosure are not limited thereto.

The enclosure 310 according to an embodiment of the present disclosure may be configured in a plastic material such as plastic or styrene material, but embodiments of the present disclosure are not limited thereto. For example, a material of the enclosure 310 may be the same or substantially the same as that of the headrest part 100 or the headrest frame 110 described above with reference to FIGS. 1 to 5, and thus, its repeated descriptions are omitted.

The enclosure 310 according to an embodiment of the present disclosure may include a base plate 311, a sidewall frame 312, and an accommodating portion 313.

The base plate 311 may include a tetragonal shape or a tetragonal shape including a curved portion, but embodiments of the present disclosure are not limited thereto. The base plate 311 may include a first surface (or front surface) 311a and a second surface (or rear surface) 311r.

The sidewall frame 312 may be formed or configured along an edge portion of the base plate 311. The sidewall frame 312 may protrude from an edge portion of the first surface 311a of the base plate 311. For example, the sidewall frame 312 may be connected or vertically connected to the edge portion of the first surface 311a of the base plate 311.

The accommodating portion 313 may be configured to accommodate or support the vibration apparatus 351. For example, the accommodating portion 313 may be formed or configured on the first surface 311a of the base plate 311 surrounded by the sidewall frame 312. For example, the accommodating portion 313 may be an accommodating space, a groove, an accommodating groove, or a supporting groove, but embodiments of the present disclosure are not limited thereto.

The enclosure 310 according to an embodiment of the present disclosure may further include one or more connection portions (or coupling portions) 315.

The one or more connection portions 315 may be formed or configured at a first side 311s of the enclosure 310. The one or more connection portions 315 may be connected or coupled to the one or more first connection members 215a of the headrest part 200 described above with reference to FIGS. 8 and 9. Accordingly, the first sound generating apparatus 300-1 or the enclosure 310 may tilt (or rotate) at a predetermined first angle (θ1) from the first side 200a of the headrest part 200.

The vibration apparatus 351 may be between the enclosure 310 and the cushion member 370 and may be configured to output a first sound (or right channel sound). The vibration apparatus 351 may be accommodated into or supported by the accommodating portion 313 of the enclosure 310 to output the first sound. For example, the vibration apparatus 351 may be configured to be supported by a first supporting portion 314a of the enclosure 310. For example, an edge portion of the vibration apparatus 351 may be configured to be supported by the first supporting portion 314a.

The first supporting portion 314a of the enclosure 310 may be configured along an edge portion of the accommodating portion 313. The first supporting portion 314a of the enclosure 310 may be configured to support an edge portion of the vibration apparatus 351. For example, the first supporting portion 314a may protrude from an inner surface of the accommodating portion 313 to a center portion of the accommodating portion 313. For example, an upper surface (or supporting surface) of the first supporting portion 314a may be between a bottom surface of the accommodating portion 313 and an upper surface of the sidewall frame 312. For example, the vibration apparatus 351 may be supported by the upper surface of the first supporting portion 314a, and thus, the vibration apparatus 351 may be accommodated into the accommodating portion 313 and may be surrounded by the sidewall frame 312.

The vibration apparatus 351 according to an embodiment of the present disclosure may be configured to include a piezoelectric material. The vibration apparatus 351 may vibrate (or displace) based on a piezoelectric effect based on the driving signal (or vibration driving signal or voice signal) to output (or generate) a sound (or a sound wave). For example, the vibration apparatus 351 may be a piezoelectric type vibration apparatus which includes the piezoelectric material. For example, the vibration apparatus 351 may include a piezoelectric material, and thus, may output a sound of a clear middle-high pitched sound band. For example, the vibration apparatus 351 may be configured to output a sound of about 200 Hz to about 20 kHz.

The vibration apparatus 351 according to an embodiment of the present disclosure may include a vibration member 351a and a vibration element 351b.

The vibration member 351a may output a first sound based on a vibration (or displacement) of the vibration element 351b. For example, the vibration member 351a may be a diaphragm, a vibration plate, a vibration substrate, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 351a may include a single nonmetal material or a composite nonmetal material, but embodiments of the present disclosure are not limited thereto. For example, a material of the vibration member 351a may be the same or substantially the same as that of the headrest part 200 or the vibration member 151a described above with reference to FIGS. 4 and 5, and thus, its repeated descriptions are omitted.

The vibration member 351a may be accommodated into the accommodating portion 313 of the enclosure 310 and may be connected or coupled to the first supporting portion 314a of the enclosure 310 by using the coupling member 353. For example, the vibration member 351a may be spaced apart from a bottom surface of the accommodating portion 313. For example, a center portion, except an edge portion, of the vibration member 351a may be spaced apart from the bottom surface of the accommodating portion 313. The vibration member 351a may be configured at the accommodating portion 113. For example, the vibration member 351a may be configured to cover the accommodating portion 313. For example, the vibration member 351a may have a same shape as that of the accommodating portion 313 and may have a size which is greater than that of the accommodating portion 313, so as to cover the accommodating portion 313, but embodiments of the present disclosure are not limited thereto.

The coupling member 353 may be disposed (or interposed) between the enclosure 310 and the vibration member 351a. For example, the coupling member 353 may be disposed (or interposed) between the first supporting portion 314a of the enclosure 310 and the vibration member 351a. For example, the coupling member 353 may be disposed (or interposed) between the first supporting portion 314a and a rear edge portion of the vibration member 351a.

The vibration element 351b may be configured to vibrate (or displace) the vibration member 351a. For example, the vibration element 351b may be configured to vibrate (or displace or driven) the vibration member 351a by a vibration (or displacement or driving) based on the driving signal (or vibration driving signal or voice signal). For example, the vibration element 351b may output (or generate) the first sound by using the vibration member 351a as a vibration plate. For example, the vibration element 351b may include a piezoelectric type vibration element which include a piezoelectric effect. For example, the vibration element 351b may be a vibration generating device, a vibration film, a vibration generating film, a vibrator, an active vibrator, an active vibration generator, an actuator, an exciter, a film actuator, a film exciter, an ultrasonic actuator, or an active vibration member, or the like, but embodiments of the present disclosure are not limited thereto.

The vibration element 351b may be disposed (or connected to) or configured at the accommodating portion 313 of the enclosure 310 to vibrate (or displace) the vibration member 351a. The vibration element 351b may be disposed (or connected to) or configured at the vibration member 351a. For example, the vibration element 351b may be disposed (or connected to) or configured at one or more of a first surface and a second surface, which is opposite to the first surface, of the vibration member 351a. As an embodiment of the present disclosure, the vibration element 351b may be disposed (or connected to) or configured at the first surface of the vibration member 351a. As another embodiment of the present disclosure, the vibration element 351b may be disposed (or connected to) or configured at the second surface of the vibration member 351a. As another embodiment of the present disclosure, the vibration element 351b may be disposed (or connected to) or configured at each of the first surface and the second surface of the vibration member 351a. For example, the vibration element 351b may have a bimorph structure disposed with the vibration member 351a therebetween.

The vibration apparatus 251 according to an embodiment of the present disclosure may further include an adhesive member 351c. For example, the vibration element 351b may be connected or coupled to the vibration member 351a by using the adhesive member 351c.

The vibration element 351b may be connected or coupled to one or more of a first surface and a second surface, which is opposite to the first surface, of the vibration member 351a by using the adhesive member 351c. For example, the vibration element 351b may be connected (or coupled) to a rear surface of the vibration member 351a by using the adhesive member 351c and may be spaced apart from a bottom surface of the accommodating portion 313 of the enclosure 310.

The first sound generating apparatus 300-1 according to an embodiment of the present disclosure may further include a cover 355.

The cover 355 may be configured to absorb an impact applied to the enclosure 310 and/or the vibration apparatus 351. The cover 355 may be configured at the vibration apparatus 351. For example, the cover 355 may be configured to cover the vibration apparatus 351. For example, the cover 355 may be between the enclosure 310 and the cushion member 370. For example, the cover 355 may be disposed or configured between the enclosure 310 and the cushion member 370 to cover the vibration apparatus 351. For example, the cover 355 may be disposed or configured between the vibration apparatus 351 and the cushion member 370.

The cover 355 according to an embodiment of the present disclosure may be accommodated into or supported by the accommodating portion 313 of the enclosure 310. For example, the cover 355 may be configured to be supported by a second supporting portion 314b of the enclosure 310. For example, an edge portion of the cover 355 may be configured to be supported by the second supporting portion 314b to cover the accommodating portion 313.

The second supporting portion 314b of the enclosure 310 may be configured along an edge portion of the accommodating portion 313. The second supporting portion 314b of the enclosure 310 may be configured to support an edge portion of the cover 355. For example, the second supporting portion 314b may protrude from an inner surface of an upper side of the accommodating portion 313 to a center portion of the accommodating portion 313. For example, an upper surface (or supporting surface) of the second supporting portion 314b may be between the first supporting portion 314a and an upper surface of the sidewall frame 312. For example, a portion of the cover 355 may be supported by the upper surface of the second supporting portion 314b, and thus, the portion of the cover 355 may be accommodated into the accommodating portion 313 and may be surrounded by the sidewall frame 312.

The cover 355 according to an embodiment of the present disclosure may be connected (or coupled) to the enclosure 310 by a plurality of fastening members. For example, the plurality of fastening members may be fastened to the second supporting portion 314b of the enclosure 310 through the cover 355. For example, each of the plurality of fastening members may be a screw or a bolt, but embodiments of the present disclosure are not limited thereto.

The cover 355 according to an embodiment of the present disclosure may be configured to have ae same size and shape as those of the accommodating portion 313 of the enclosure 310, but embodiments of the present disclosure are not limited thereto. For example, the cover 355 may include a material which absorbs an impact. For example, the cover 355 may include a foam material or a sponge material, but embodiments of the present disclosure are not limited thereto. For example, the cover 355 may be a cushion cover, a foam cover, a sponge cover, or a buffer cover, but embodiments of the present disclosure are not limited thereto.

The cover 155 according to an embodiment of the present disclosure may include a sound emission portion 355h.

The sound emission portion 355h may be configured to overlap (or correspond to) the vibration apparatus 351. For example, the sound emission portion 355h may be a path through which a first sound generated (or output) by the vibration apparatus 351 is output to the outside (or cushion member 370). For example, the sound emission portion 355h may be configured to pass through the cover 355 along a thickness direction Z of the cover 355.

The sound emission portion 355h according to an embodiment of the present disclosure may be configured to include one or more holes (or sound holes or sound emission holes).

The sound emission portion 355h according to another embodiment of the present disclosure may be configured to include one or more holes (or sound holes or sound emission holes) based on a mesh structure 355m.

Referring to FIGS. 6, 10, and 11, the cushion member 370 may be configured to overlap (or correspond to) the vibration apparatus 351. For example, the cushion member 370 may be between the sheath member 290 and the vibration apparatus 351. For example, the cushion member 370 may be between the cover 355 and the sheath member 290. For example, the cushion member 370 may be a cushion pad, but embodiments of the present disclosure are not limited thereto.

According to an embodiment of the present disclosure, the cushion member 370 may be a path through which the first sound generated (or output) by the vibration apparatus 351 is output. The cushion member 370 may be configured (or disposed) to cover the sound emission portion 355h. For example, the cushion member 370 may be supported by the cover 355. A rear surface of the cushion member 370 may be supported by the mesh structure 355m in the sound emission portion 355h of the cover 355.

The cushion member 370 according to an embodiment of the present disclosure may include a material which may output a sound and may absorb an impact. For example, the cushion member 370 may include a foam material or a sponge material, but embodiments of the present disclosure are not limited thereto.

The cushion member 370 according to another embodiment of the present disclosure may include a porous material, but embodiments of the present disclosure are not limited thereto. For example, the cushion member 370 may include a porous material including a plurality of porous holes 370h. For example, the plurality of porous holes 370h may be configured regularly or irregularly. For example, the cushion member 370 may include an air mesh material. For example, the cushion member 370 may include the plurality of porous holes (or sound through hole) 370h and a cushion layer having a mesh material.

According to an embodiment of the present disclosure, in the first sound generating apparatus 300-1, the first sound generated by the vibration apparatus 351 may be output to the outside through the sound emission portion 355h of the cover 355 and the cushion member 370.

Referring to FIGS. 8, 10, and 11, the first sound generating apparatus 300-1 according to an embodiment of the present disclosure may further include a sound blocking member 380.

The sound blocking member 380 may be configured to block the first sound which is output in a rearward direction of the enclosure 310. For example, the sound blocking member 380 may be between the enclosure 310 and the sheath member 290. For example, the sound blocking member 380 may be between the rear surface 311r of the enclosure 310 and the sheath member 290. The sound blocking member 380 may be disposed (or configured) at or connected (or coupled) to the rear surface 311r of the enclosure 310 and may be covered by the sheath member 290. For example, the sound blocking member 380 may be connected (or coupled) or attached to the rear surface 311r of the enclosure 310 and may be covered by the sheath member 290.

The sound blocking member 380 may include a material for blocking or absorbing a sound. For example, the sound blocking member 380 may include rubber, but embodiments of the present disclosure are not limited thereto. For example, the sound blocking member 380 may be ethylene propylene rubber or urethane rubber, but embodiments of the present disclosure are not limited thereto. For example, the ethylene propylene rubber may be ethylene propylene diene monomer (EPDM), but embodiments of the present disclosure are not limited thereto.

The first sound generating apparatus 300-1 according to an embodiment of the present disclosure may be connected (or coupled) to the first side 200a of the headrest part 200 and may output the first sound. For example, the first sound generating apparatus 300-1 may output the first sound which is generated based on a vibration (or displacement or driving) of the vibration apparatus 351 which includes the piezoelectric material, and thus, may output the first sound of a clear middle-high pitched sound band. For example, the first sound generating apparatus 300-1 according to an embodiment of the present disclosure may be configured to output the first sound of about 200 Hz to about 20 kHz.

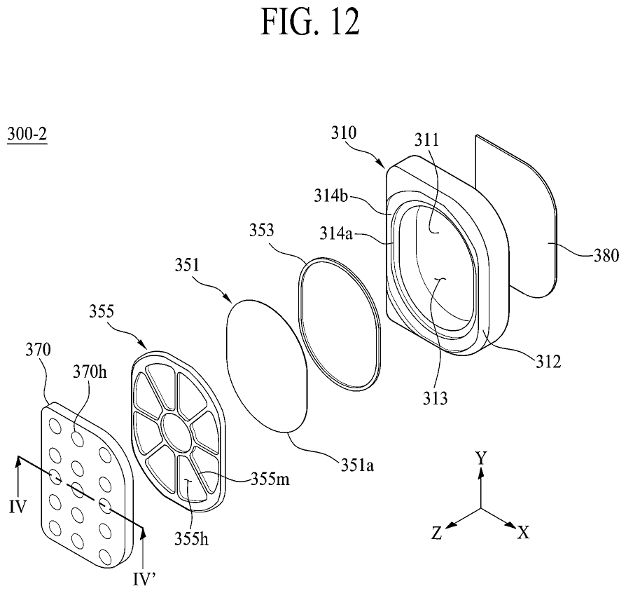

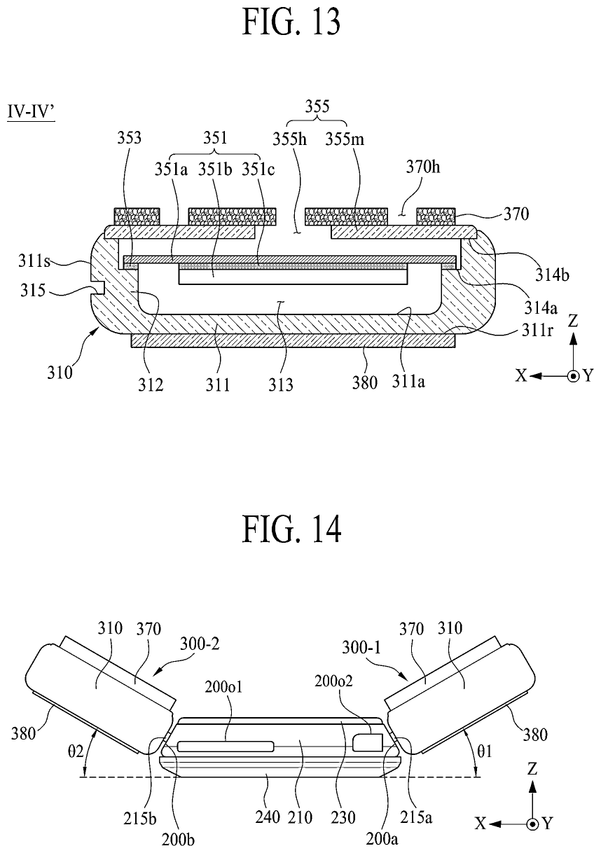

FIG. 12 is an exploded perspective view illustrating a second sound generating apparatus illustrated in FIGS. 6 to 8 according to an embodiment of the present disclosure. FIG. 13 is a cross-sectional view taken along line IV-IV′ illustrated in FIG. 12.

Referring to FIGS. 8, 12, and 13, a second sound generating apparatus 300-2 according to an embodiment of the present disclosure may include an enclosure 310, a vibration apparatus 351, and a cushion member 370.

The enclosure 310 may be at the second side 200b of the headrest part 200. The second sound generating apparatus 300-2 may be configured to be connected (or supported) or fixed (or coupled) to the second side 200b of the headrest part 200. The enclosure 310 may include a tetragonal shape or a tetragonal shape including a curved portion, but embodiments of the present disclosure are not limited thereto.

The enclosure 310 may include a base plate 311, a sidewall frame 312, and an accommodating portion 313. For example, the base plate 311, the sidewall frame 312, and the accommodating portion 313 may be the same or substantially the same as that of the base plate 311, the sidewall frame 312, and the accommodating portion 313 of the first sound generating apparatus 300-1 described above with reference to FIGS. 10 and 11, and thus, like reference numerals refer to like elements and its repeated descriptions are omitted.

The enclosure 310 according to an embodiment of the present disclosure may further include one or more connection portions (or coupling portions) 315. The one or more connection portions 315 may be connected or coupled to the one or more second connection members 215b of the headrest part 200 described above with reference to FIGS. 8 and 9. Accordingly, the second sound generating apparatus 300-2 or the enclosure 310 may tilt (or rotate) at a predetermined second angle (θ2) from the second side 200b of the headrest part 200.

The vibration apparatus 351 may be between the enclosure 310 and the cushion member 370 and may be configured to output a second sound (or left channel sound). The vibration apparatus 351 may be accommodated into or supported by the accommodating portion 313 of the enclosure 310 to output the second sound. For example, the vibration apparatus 351 may be configured to be supported by a first supporting portion 314a of the enclosure 310. For example, the vibration apparatus 351 may be the same or substantially the same as that of the vibration apparatus 351 described above with reference to FIGS. 10 and 11, and thus, like reference numerals refer to like elements and its repeated descriptions are omitted.

The second sound generating apparatus 300-2 according to an embodiment of the present disclosure may further include a cover 355.

The cover 355 may be configured to absorb an impact applied to the enclosure 310 and/or the vibration apparatus 351. The cover 355 may be configured at the vibration apparatus 351. For example, the cover 355 may be configured to cover the vibration apparatus 351. For example, the cover 355 may be between the enclosure 310 and the cushion member 370. For example, the cover 355 may be disposed or configured between the enclosure 310 and the cushion member 370 to cover the vibration apparatus 351. For example, the cover 355 may be the same or substantially the same as that of the cover 355 described above with reference to FIGS. 10 and 11, and thus, like reference numerals refer to like elements and its repeated descriptions are omitted.

The cushion member 370 may be configured to overlap (or correspond to) the vibration apparatus 351. For example, the cushion member 370 may be between the vibration apparatus 351 and the sheath member 290. For example, the cushion member 370 may be between the cover 355 and the sheath member 290. For example, the cushion member 370 may be a path through which the second sound generated (or output) by the vibration apparatus 351 is output. For example, the cushion member 370 may be the same or substantially the same as that of the cushion member 370 described above with reference to FIGS. 10 and 11, and thus, like reference numerals refer to like elements and its repeated descriptions are omitted.

The second sound generating apparatus 300-2 according to an embodiment of the present disclosure may further include a sound blocking member 380.

The sound blocking member 380 may be configured to block the second sound which is output in a rearward direction of the enclosure 310. For example, the sound blocking member 380 may be between the enclosure 310 and the sheath member 290. For example, the sound blocking member 380 may be between the rear surface 311r of the enclosure 310 and the sheath member 290. The sound blocking member 380 may be the same or substantially the same as that of the sound blocking member 380 described above with reference to FIGS. 10 and 11, and thus, like reference numerals refer to like elements and its repeated descriptions are omitted.

The second sound generating apparatus 300-2 according to an embodiment of the present disclosure may be connected (or coupled) to the second side 200b of the headrest part 200 and may output the second sound. For example, the second sound generating apparatus 300-2 may output the second sound which is generated based on a vibration (or displacement or driving) of the vibration apparatus 351 which includes the piezoelectric material, and thus, may output the second sound of a clear middle-high pitched sound band. For example, the second sound generating apparatus 300-2 according to an embodiment of the present disclosure may be configured to output the second sound of about 200 Hz to about 20 kHz.

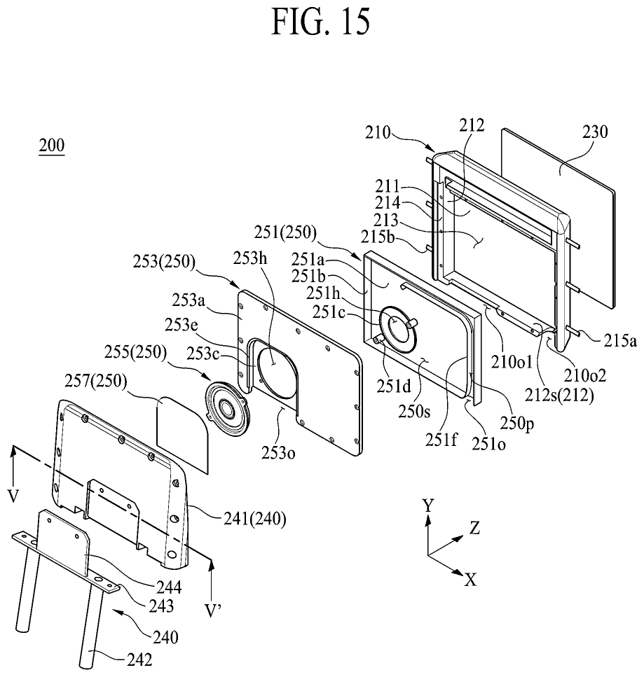

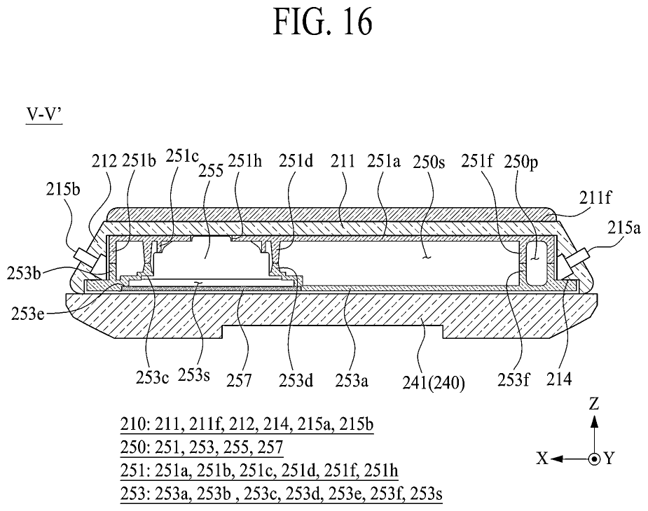

FIG. 14 is a rear view illustrating a headrest according to another embodiment of the present disclosure. FIG. 15 is a perspective view illustrating a headrest according to another embodiment of the present disclosure. FIG. 16 is a cross-sectional view taken along line V-V′ illustrated in FIG. 14. FIGS. 14 to 16 illustrate an embodiment where a third sound generating apparatus is additionally configured on the headrest part of the headrest described above with reference to FIGS. 6 to 13. In the following description, therefore, a third sound generating apparatus and relevant elements will be described in detail, the other elements may be a same or substantially a same as that of descriptions described above with reference to FIGS. 6 to 13, and thus, like reference numerals refer to like elements and its repeated descriptions may be omitted or will be briefly given below. Therefore, descriptions above with reference to FIGS. 6 to 13 may be included in descriptions of FIGS. 14 to 16.

Referring to FIGS. 14 to 16, a headrest 20 according to another embodiment of the present disclosure may further include a third sound generating apparatus 250 which is on a headrest part 200.

The headrest part 200 according to another embodiment of the present disclosure may include a headrest frame 210, the third sound generating apparatus 250, and a cushion member 230.

The headrest frame 210 may include an accommodating portion 213. The accommodating portion 213 may be configured to accommodate (or receive) the third sound generating apparatus 250.

The headrest frame 210 may include a base frame 211, a sidewall frame 212, and an accommodating portion 213.

The base frame 211 may include a tetragonal shape or a tetragonal shape including a curved portion, but embodiments of the present disclosure are not limited thereto. The base frame 211 may include a first surface (or front surface) and a second surface (or rear surface) 211r.

The sidewall frame 212 may be formed or configured along an edge portion of the base frame 211. The sidewall frame 212 may protrude from an edge portion of the first surface of the base frame 211. For example, the sidewall frame 212 may be connected or vertically connected to the edge portion of the first surface of the base frame 211.

The accommodating portion 213 may be formed or configured in the base frame 211. For example, the accommodating portion 213 may be formed or configured in the base frame 211 to accommodate or support the third sound generating apparatus 250. For example, the accommodating portion 213 may be formed or configured in the base frame 111 by the sidewall frame 212 protruding from the first surface of the base frame 211. For example, the accommodating portion 213 may be an accommodating space, a groove, an accommodating groove, or a supporting groove, but embodiments of the present disclosure are not limited thereto.

The headrest part 200 according to an embodiment of the present disclosure may further include one or more first connection members 215a and one or more second connection members 215b.

The one or more first connection members 215a may protrude to have a predetermined length from a first side 200a of the headrest frame 210. The one or more first connection members 215a may be configured to tilt (or rotate) at a predetermined first angle (θ1) from the first side 200a of the headrest frame 210. The one or more first connection members 215a may be connected to one surface of the first sound generating apparatus 300-1. For example, end portions of the one or more first connection members 215a may be accommodated into the one or more connection portions 315 in the enclosure 310 of the first sound generating apparatus 300-1 illustrated in FIGS. 10 and 11.

The one or more second connection members 215b may protrude to have a predetermined length from a second side 200b of the headrest frame 210. The one or more second connection members 215b may be configured to tilt (or rotate) at a predetermined second angle (θ2) from the second side 200b of the headrest frame 210. The one or more second connection members 215b may be connected to one surface of the second sound generating apparatus 300-2. For example, end portions of the one or more second connection members 215b may be accommodated into the one or more connection portions 315 in the enclosure 310 of the second sound generating apparatus 300-2 illustrated in FIG. 13.

The headrest part 200 according to an embodiment of the present disclosure may further include a first sound emission port 20001 and a second sound emission port 20002.

The first sound emission port (or first sound emission hole) 20001 may be configured in a lower portion of the headrest frame 210, or may be connected to the accommodating portion 213. For example, the first sound emission port 20001 may be configured (or formed) in a portion of a sidewall frame, corresponding to a lower portion of the headrest frame 210, of the sidewall frame 212 of the headrest frame 210. For example, the first sound emission port 20001 may be configured (or formed) to pass through a portion of the sidewall frame 212 and may be connected to the accommodating portion 213. For example, the first sound emission port 20001 may be disposed (or configured) in a lower surface of the headrest part 200 and may face the ground.

The second sound emission port (or second sound emission hole) 20002 may be configured in the lower portion of the headrest frame 210 in parallel with the first sound emission port 20001 and may be connected to the accommodating portion 213. For example, the second sound emission port 20002 may be configured (or formed) in a portion of the sidewall frame 212 so as to be adjacent to the first side 200a in the sidewall frame 212 of the headrest frame 210. For example, the second sound emission port 20002 may be configured (or formed) to pass through a portion of the sidewall frame 212 and may be connected to the accommodating portion 213. For example, the second sound emission port 20002 may be disposed (or configured) in the lower surface of the headrest part 200 and may face the ground.

The third sound generating apparatus 250 may be disposed (or configured) in the headrest frame 210 to output a third sound. The third sound generating apparatus 250 may be accommodated (or received) into the accommodating portion 213 of the headrest frame 210 and may be configured to output the third sound. For example, the third sound output from the third sound generating apparatus 250 may differ from each of the first sound output from the first sound generating apparatus 300-1 and the second sound output from the second sound generating apparatus 300-2. For example, the third sound output from the third sound generating apparatus 250 may include a low-pitched sound band.

The third sound generating apparatus 250 according to an embodiment of the present disclosure may be a woofer speaker, but embodiments of the present disclosure are not limited thereto. For example, the third sound generating apparatus 250 may be one or more of a woofer, a mid-woofer, and a sub-woofer, but embodiments of the present disclosure are not limited thereto. For example, the third sound generating apparatus 250 may be a speaker which outputs the third sound of 30 Hz to 200 Hz or 300 Hz or less, but embodiments of the present disclosure are not limited thereto. Accordingly, the third sound generating apparatus 250 may output the third sound of 30 Hz to 200 Hz or 300 Hz or less, and thus, may enhance a sound characteristic of a low-pitched sound band of a sound output from the headrest 20.

The third sound generating apparatus 250 according to an embodiment of the present disclosure may be a coil-type vibration apparatus or a coil-type actuator. For example, the third sound generating apparatus 250 may vibrate (or driven) based on a driving signal (or vibration driving signal or voice signal) to output (or generate) the third sound (or sound wave or low sound), based on Fleming's left hand rule.

The third sound generating apparatus 250 according to an embodiment of the present disclosure may include a first enclosure 251, a second enclosure 253, an actuator 255, and a cover plate 257.

The first enclosure 251 may be configured at the second enclosure 253 and the actuator 255. The first enclosure 251 may be configured to support the second enclosure 253 and the actuator 255. The first enclosure 251 may be configured to include a sound space 250s and a sound emission path 250p. The sound emission path 250p may be configured to be connected to (or communicated with) the second sound emission port 20002 in the headrest frame 210.

The first enclosure 251 according to an embodiment of the present disclosure may include a base plate (or a first base plate) 251a, a sidewall (or a first sidewall) 251b, a sound space 250s, an opening portion (or a first opening portion) 2510, a partition 251f, and the sound emission path 250p.

The base plate 251a may be configured to have a shape and a size corresponding to the accommodating portion 213 of the headrest frame 210. A rear surface of the base plate 251a may be supported by a bottom surface of the accommodating portion 213 of the headrest frame 210.

The sidewall 251b may be formed or configured along an edge portion of the base plate 251a. The sidewall 251b may protrude from an edge portion of a front surface of the base plate 251a. For example, the sidewall 251b may be connected or vertically connected to the edge portion of the front surface of the base plate 251a. For example, the sidewall 251b may form (or configure) a sound space 250s on a front surface of the base plate 251a. For example, the sound space 250s may be surrounded by the sidewall 251b.

The sidewall 251b according to an embodiment of the present disclosure may include first to fourth sidewalls corresponding to an edge portion of the base plate 251a. For example, the sidewall 251b may include a first sidewall parallel to a first long side of the base plate 251a, a second sidewall parallel to a second long side of the base plate 251a, a third sidewall parallel to a first short side of the base plate 251a, and a fourth sidewall parallel to a second short side of the base plate 251a.

The opening portion 2510 may be formed (or configured) in a portion of the sidewall 251b so as to be connected to (or communicated with) the second sound emission port 20002 which is in the headrest frame 210. For example, the opening portion 2510 may be formed (or configured) in a portion of a first sidewall, corresponding to (or overlapping) the second sound emission port 20002 in the headrest frame 210, of the sidewall 251b. Accordingly, the second sound emission port 20002 may be connected to (or communicated with) the sound space 250s of the first enclosure 251 through the first opening portion 2510.

The partition 251f may be disposed in a partial region of the first sound space 250s. For example, the partition 251f may be disposed in a partial region of the first sound space 250s and may form (or configure) the second sound emission path 250p separated from the first sound space 250s. For example, the partition 251f may include a first partition which is connected to the first sidewall, which is adjacent to the opening portion 2510, of the sidewall 251b and spaced apart from a third side wall of the sidewall 251b, a second partition spaced apart from a portion of the first sidewall of the sidewall 251b, and a third partition having a curved shape between the first partition and the second partition, but embodiments of the present disclosure are not limited thereto. For example, the partition 251f may be disposed in a partial region of the first sound space 250s spaces apart from the sidewall 251b to have an “L”-shape, but embodiments of the present disclosure are not limited thereto.

The second sound emission path 250p may be formed (or configured) in a region between the sidewall 251b and the partition 251f. For example, one side of the second sound emission path 250p may be connected to (or communicated with) the sound space 250s in a region adjacent to a fourth sidewall of the sidewall 251b. For example, the other side of the second sound emission path 250p may be the opening portion 2510, or may be connected to (or communicated with) the opening portion 2510.

The first enclosure 251 according to an embodiment of the present disclosure may include a supporting portion 251c. The supporting portion 251c may be configured to support the actuator 255. For example, the supporting portion 251c may be configured to support a rear surface of the actuator 255. For example, the supporting portion 251c may be configured or protrude from the base plate 251 to support a rear edge portion of the actuator 255. For example, the supporting portion 251c may include a circular shape, but embodiments of the present disclosure are not limited thereto. For example, the supporting portion 251c may be a protrusion supporting portion, a circular supporting portion, an actuator supporting portion, a rear supporting portion, or a supporting member, but embodiments of the present disclosure are not limited thereto.

The first enclosure 251 or the supporting portion 251c according to an embodiment of the present disclosure may further include an accommodating hole (or first accommodating hole) 251h.

The accommodating hole 251h may accommodate a portion of the actuator 255. The accommodating hole 251h may be formed (or configured) in a region surrounded by the supporting portion 251c. The accommodating hole 251h may have a smaller size than the supporting portion 251c, but embodiments of the present disclosure are not limited thereto. The supporting portion 251c may be formed (or configured) to pass through the base plate 251a. For example, at least a portion of a rear surface of the actuator 255 may be accommodated into the accommodating hole 251h.

The first enclosure 251 according to an embodiment of the present disclosure may further include a plurality of supporting projections (or a plurality of first supporting projections) 251d.

The plurality of supporting projections 251d may be at a periphery of the supporting portion 251c. For example, the supporting portion 251c may be between the plurality of supporting projections 251d. The plurality of supporting projections 251d may protrude to have a predetermined height from the base plate 251a. The plurality of supporting projections 251d may face each other with the supporting portion 251c therebetween.

The second enclosure 253 may be configured on the first enclosure 251. The second enclosure 253 may be configured to support the actuator 255 and cover the first enclosure 251. The second enclosure 253 may be configured in the sound space 250s and the sound emission path 250p. The second enclosure 253 may be configured to support the actuator 255 and cover the sound space 250s and the sound emission path 250p of the first enclosure 251. For example, the second enclosure 253 may be connected (or coupled) to the sidewall frame 212 of the headrest frame 210 to cover the sound space 250s and the sound emission path 250p of the first enclosure 251. For example, the second enclosure 253 may be connected (or coupled) to the headrest frame 210 by a plurality of fastening members. The plurality of fastening members may be fastened to the sidewall frame 212 of the headrest frame 210 through the second enclosure 253. For example, each of the plurality of fastening members may be a screw or a bolt, but embodiments of the present disclosure are not limited thereto.

The headrest frame 210 may further include a supporting surface 214. The supporting surface 214 may support the second enclosure 253. The supporting surface 214 may be formed (or configured) to be concave from an upper surface of the sidewall frame 212. The supporting surface 214 may be formed (or configured) to be concave from the upper surface of the sidewall frame 212 so as to support an edge portion of the second enclosure 253.

The second enclosure 253 according to an embodiment of the present disclosure may include a base plate (or a second base plate) 253a, a sidewall (or a second sidewall) 253b, a supporting portion (or a second supporting portion) 253c, an accommodating hole (or a first accommodating hole) 253h, and an opening portion (a second opening portion) 2530.

The base plate 253a may be configured on the first enclosure 251. The base plate 253a may be configured to support the actuator 255 and cover the first enclosure 251. The second enclosure 253 may be configured in the sound space 250s and the sound emission path 250p of the first enclosure 251. The second enclosure 253 may be configured to support the actuator 255 and cover the sound space 250s and the sound emission path 250p of the first enclosure 251.

The sidewall 253b may be formed or configured along an edge portion of the base plate 253a. The sidewall 253b may protrude from an edge portion of a front surface of the base plate 253a. For example, the sidewall frame 253b may be connected or vertically connected to the edge portion of the front surface of the base plate 253a. For example, the sidewall 253b may be formed (or configured) to be supported by the sidewall frame 212 and the partition 251f of the first enclosure 251.

The supporting portion 253c may protrude from the base plate 253a to support the actuator 255. The supporting portion 253c may be formed to be concave from the front surface of the base plate 253a so as to accommodate the actuator 255.

The accommodating hole 253h may be formed (or configured) in the supporting portion 253c. The accommodating hole 253h may be formed (or configured) in the supporting portion 253c to accommodate the actuator 255. For example, the accommodating hole 253h may pass through the supporting portion 253c to accommodate a portion of the actuator 255.

The opening portion 2530 may be formed (or configured) in one side of the supporting portion 253c so as to be connected to (or communicated with) the first sound emission port 20001 which is in the headrest frame 210. For example, the opening portion 2530 may be formed (or configured) in the supporting portion corresponding to (or overlapping) the first sound emission port 20001 which is in the headrest frame 210. Accordingly, the first sound emission port 20001 may be connected to (or communicated with) the opening portion 2530.

The second enclosure 253 according to an embodiment of the present disclosure may further include a plurality of supporting projections (or a plurality of second supporting projections) 253f which are at a periphery of the supporting portion 253c.

The plurality of supporting projections 253f may be configured to be connected (or coupled) to the plurality of supporting projections 251d which are at the first enclosure 251. The plurality of supporting projections 253f may protrude from a rear surface of the base plate 253a corresponding to (overlapping) the plurality of supporting projections 251d of the first enclosure 251.

The actuator 255 may be accommodated into the second enclosure 253 and may be configured to output the third sound. For example, the actuator 255 may be supported by or accommodated into the supporting portion 253c of the second enclosure 253. For example, a portion of the actuator 255 may be accommodated into the accommodating hole 253h which is in the supporting portion 253c of the second enclosure 253.

The actuator 255 according to an embodiment of the present disclosure may be supported by or accommodated into the second enclosure 253 or the supporting portion 253c of the second enclosure 253 by a plurality of fastening members. For example, the plurality of fastening members may be fastened to the plurality of supporting projections 251d of the first enclosure 251 through an edge portion of the actuator 255, the supporting portion 253c of the second enclosure 253, and the plurality of supporting projections 253d. For example, each of the plurality of fastening members may be a screw or a bolt, but embodiments of the present disclosure are not limited thereto.

The actuator 255 according to an embodiment of the present disclosure may include a magnet and a coil. For example, the actuator 255 may be one or more of a woofer, a mid-woofer, and a sub-woofer, but embodiments of the present disclosure are not limited thereto. For example, the actuator 255 may be a speaker which outputs the third sound of 30 Hz to 200 Hz or 300 Hz or less, but embodiments of the present disclosure are not limited thereto.

The cover plate 257 may be connected (or coupled) to the second enclosure 253. The cover plate 257 may be connected (or coupled) to the second enclosure 253 to cover the actuator 255. The cover plate 257 may be connected (or coupled) to the second enclosure 253 so as to be spaced apart from the actuator 255. The cover plate 257 may be connected (or coupled) to the second enclosure 253 to cover the actuator 255 with a gap space 253s therebetween. For example, the cover plate 257 may be connected (or coupled) to the supporting portion 253c of the second enclosure 253 to cover the actuator 255. For example, the cover plate 257 may be connected (or coupled) to the supporting portion 253c of the second enclosure 253 to cover the actuator 255 with a gap space 253s therebetween.

The cover plate 257 may be configured to have a shape and a size corresponding to the supporting portion 253c of the second enclosure 253, but embodiments of the present disclosure are not limited thereto. For example, the cover plate 257 may be supported by or attached to a supporting surface 253e which is in the supporting portion 253c of the second enclosure 253. For example, the supporting surface 253e of the second enclosure 253 may be formed (or configured) to be concave along a periphery of the supporting portion 253c, but embodiments of the present disclosure are not limited thereto.

The gap space 253s may be between the cover plate 257 and the actuator 255 and may be connected to (or communicated with) the opening portion 2530. For example, the third sound generated based on driving (or vibration) of the actuator 255 may be output in a lower-surface direction of the headrest 20 through the gap space 253s, the opening portion 2530, and the first sound emission port 20001.

In the third sound generating apparatus 250 according to an embodiment of the present disclosure, the sound space 250s and the sound emission path 250p provided (or configured) by the first enclosure 251 and the second enclosure 253 may configure a Helmholtz resonator.

According to an embodiment of the present disclosure, the sound space 250s may be a volume of the Helmholtz resonator, but embodiments of the present disclosure are not limited thereto. The sound emission path 250p may be a sound guide pipe or a sound pipe, but embodiments of the present disclosure are not limited thereto. For example, the sound emission path 250p may extend to the opening portion 2510, and thus, a total length of the sound emission path 250p may be an opening portion length of the Helmholtz resonator, but embodiments of the present disclosure are not limited thereto. In addition, a cross-sectional area of the opening portion 2510 may be a hole area of the Helmholtz resonator, but embodiments of the present disclosure are not limited thereto.

The sound emission path 250p according to an embodiment of the present disclosure may amplify the third sound generated by the third sound generating apparatus 250 by using a resonance of a pipe, and thus, may reinforce a frequency characteristic of a low-pitched sound band of the third sound. For example, the third sound generated by the third sound generating apparatus 250 may be amplified based on a pipe vibration of the sound emission path 250p and may thus be output in the lower-surface direction of the headrest 20 through the opening portion 251o and the second sound emission hole 21002.

The headrest part 200 according to an embodiment of the present disclosure may further include a support rod part 240.

The support rod part 240 according to an embodiment of the present disclosure may be connected (or coupled) to the headrest frame 210. The support rod part 240 according to an embodiment of the present disclosure may be connected (or coupled) to the headrest frame 210 to cover the third sound generating apparatus 250. The support rod part 240 may be configured to be connected (or coupled) to a lower surface of the headrest frame 210, or may be configured to support the lower surface of the headrest frame 210. For example, the support rod part 240 may include one or more support rods 242.

The one or more support rods 242 may be configured to be connected to the lower surface of the headrest frame 210. For example, the support rod part 240 may include a pair of support rods 242, but embodiments of the present disclosure are not limited thereto. For example, the one or more (or a pair of) support rods 242 may be connected to an upper portion of a seatback of a seat for vehicle or a backrest frame of a chair.

The support rod part 240 according to another embodiment of the present disclosure may be configured to be connected (or coupled) to a rear surface of the headrest part 200 or the headrest frame 210, or may be configured to support the rear surface of the headrest part 200 or the headrest frame 210.

The support rod part 240 according to another embodiment of the present disclosure may include a support frame 241 and one or more support rods 242.

The support frame 241 may be configured to be connected (or coupled) to the rear surface of the headrest frame 210, or may be configured to support the rear surface of the headrest frame 210 to cover the third sound generating apparatus 250.

The one or more support rods 242 may be configured to be connected to a lower surface and a rear surface of the support frame 241. For example, the support rod part 240 may include a pair of support rods 242, but embodiments of the present disclosure are not limited thereto. For example, the one or more (or a pair of) support rods 242 may be connected to an upper portion of a seatback of a seat for vehicle or a backrest frame of a chair.

The support rod part 240 according to another embodiment of the present disclosure may further include a first support plate 243 and a second support plate 244.

The first support plate 243 may be connected (or coupled) to the lower surface of the support frame 241 by a plurality of second fastening members. The second support plate 244 may be connected (or coupled) to the rear surface of the support frame 241. For example, the second support plate 244 may be connected (or coupled) to one side of the first support plate 243 and may be connected (or coupled) to the rear surface of the support frame 241. For example, the first support plate 243 and the second support plate 244 may be the same or substantially the same as that of the first support plate 243 and the second support plate 244 of the support rod part 240 described above with reference to FIG. 9, and thus, its repeated descriptions are omitted.

The cushion member 230 may be at a front surface 211f of the headrest frame 210. For example, the cushion member 230 may be configured to cover the front surface 211f of the headrest frame 210. For example, the cushion member 230 may include a material which absorbs an impact. For example, the cushion member 230 may be the same or substantially the same as that of the cushion member 230 described above with reference to FIG. 9, and thus, its repeated descriptions are omitted.

The headrest 20 according to another embodiment of the present disclosure may further include the third sound generating apparatus 250, and thus, may additionally output the third sound generated based on a vibration (or driving) of the third sound generating apparatus 250. For example, the headrest 20 according to another embodiment of the present disclosure may output a 3-channel stereo sound or stereophonic sound which includes the first sound (or the right channel sound) based on the first sound generating apparatus 300-1, the second sound (or the left channel sound) based on the second sound generating apparatus 300-2, and the third sound based on the third sound generating apparatus 250. For example, the headrest 20 according to another embodiment of the present disclosure may respectively output the first sound and the second sound of a middle-high pitched sound band through the first sound generating apparatus 300-1 and the second sound generating apparatus 300-2 and may output the third sound of a low-pitched sound band through the third sound generating apparatus 250, and thus, may reproduce (or output) a sound of a full pitched sound band.

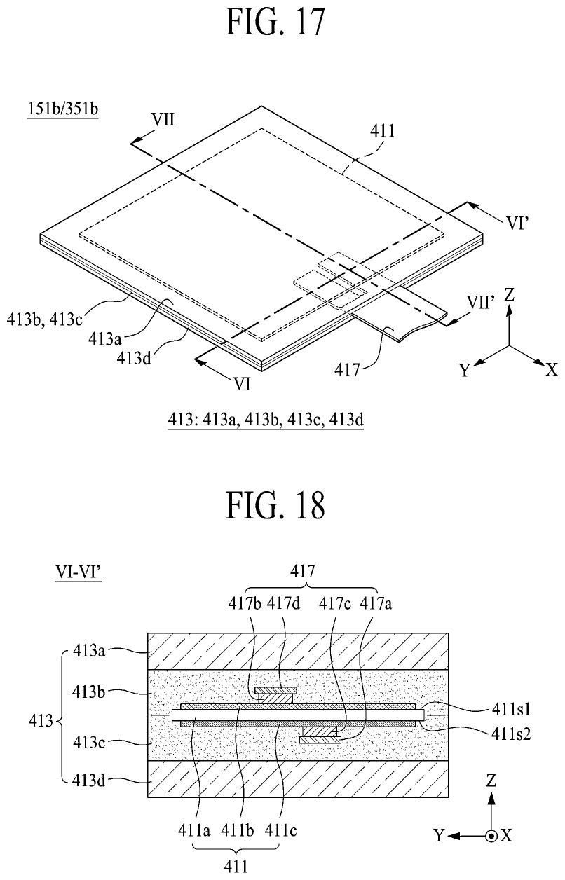

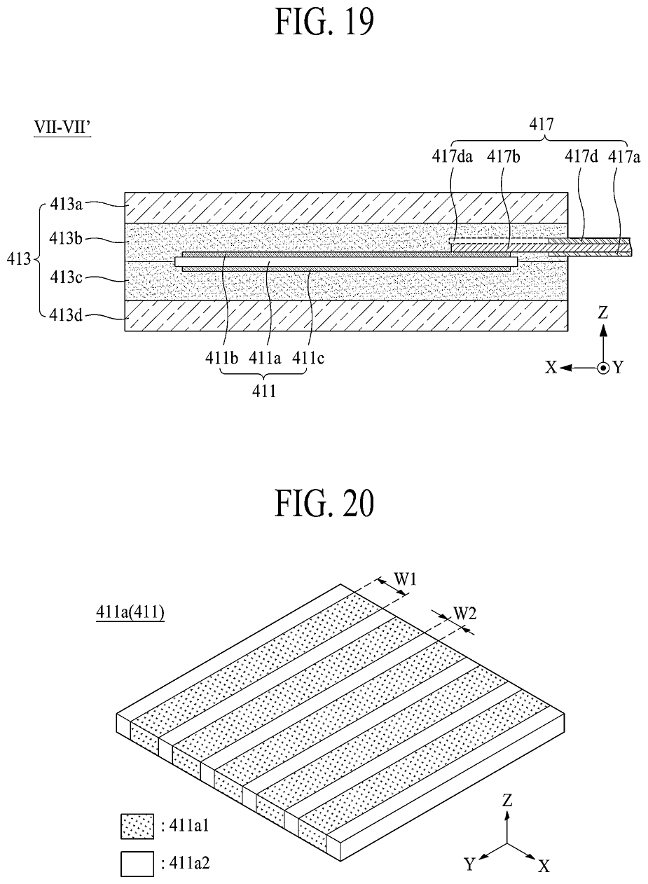

FIG. 17 is a perspective view illustrating a vibration element according to an embodiment of the present disclosure. FIG. 18 is a cross-sectional view taken along line VI-VI′ illustrated in FIG. 17. FIG. 19 is a cross-sectional view taken along line VII-VII′ illustrated in FIG. 17. For example, FIGS. 17 to 19 illustrate the vibration element of the vibration apparatus described above with reference to FIGS. 1 to 13.

Referring to FIGS. 17 to 19, the vibration element 151b and 351b according to an embodiment of the present disclosure may include a piezoelectric material having a piezoelectric characteristic.

The vibration element 151b and 351b may be configured as a ceramic-based piezoelectric material for implementing a relatively strong vibration, or may be configured as a piezoelectric ceramic having a perovskite-based crystal structure.

The vibration element 151b and 351b according to an embodiment of the present disclosure may include a vibration part 411.

The vibration part 411 may be configured to vibrate by a piezoelectric effect based on a piezoelectric driving signal. The vibration part 411 may include at least one of a piezoelectric inorganic material and a piezoelectric organic material. For example, the vibration part 411 may be a vibration element, a piezoelectric element layer, a piezoelectric structure, a piezoelectric vibration part, or a piezoelectric vibration layer, or the like, but embodiments of the present disclosure are not limited thereto.

The vibration part 411 according to an embodiment of the present disclosure may include a vibration layer 411a, a first electrode layer 411b, and a second electrode layer 411c.

The vibration layer 411a may include a piezoelectric material or an electroactive material which has a piezoelectric effect. For example, the piezoelectric material may have a characteristic in which, when pressure or twisting phenomenon is applied to a crystalline structure by an external force, a potential difference occurs due to dielectric polarization caused by a relative position change of a positive (+) ion and a negative (−) ion, and a vibration is generated by an electric field based on a reverse voltage applied thereto. For example, the vibration layer 411a may be a piezoelectric layer, a piezoelectric material layer, an electroactive layer, a piezoelectric composite layer, a piezoelectric composite, or a piezoelectric ceramic composite, or the like, but embodiments of the present disclosure are not limited thereto.

The vibration layer 411a may be configured as a ceramic-based material for implementing a relatively strong vibration, or may be configured as a piezoelectric ceramic having a perovskite-based crystalline structure. The perovskite crystalline structure may have a piezoelectric effect and/or an inverse piezoelectric effect and may be a plate-shaped structure having orientation.

The piezoelectric ceramic may be configured as a single crystalline ceramic having a single crystalline structure, or may be configured as a ceramic material or polycrystalline ceramic having a polycrystalline structure. A piezoelectric material including the single crystalline ceramic may include α-AlPO₄, α-SiO₂, LiNbO₃, Tb₂(MoO₄)₃, Li₂B₄O₇, or ZnO, but embodiments of the present disclosure are not limited thereto. A piezoelectric material including the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but embodiments of the present disclosure are not limited thereto. For example, the vibration layer 411a may include at least one of calcium titanate (CaTiO₃), barium titanate (BaTiO₃), and strontium titanate (SrTiO₃), without lead (Pb), but embodiments of the present disclosure are not limited thereto.

The first electrode layer 411b may be disposed at a first surface (or an upper surface or a front surface) 411s1 of the vibration layer 411a. The first electrode layer 411b may have a same size as that of the vibration layer 411a, or may have a size which is smaller than that of the vibration layer 411a.

The second electrode layer 411c may be disposed at a second surface (or a lower surface or a rear surface) 411s2 which is opposite to or different from the first surface 11s1 of the vibration layer 411a. The second electrode layer 411c may have a same size as that of the vibration layer 411a, or may have a size which is smaller than that of the vibration layer 411a. For example, the second electrode layer 411c may have a same shape as that of the vibration layer 411a, but embodiments of the present disclosure are not limited thereto.

According to an embodiment of the present disclosure, one or more of the first electrode layer 411b and the second electrode layer 411c may be formed of a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be formed of an alloy thereof, but embodiments of the present disclosure are not limited thereto. For example, to enhance an electrical characteristic and/or a vibration characteristic of the vibration layer 411a, each of the first electrode layer 411b and the second electrode layer 411c may include silver (Ag) having a low resistivity. For example, carbon may be carbon black, ketjen black, carbon nanotube, and a carbon material including graphite, but embodiments of the present disclosure are not limited thereto.

The vibration layer 411a may be polarized by a certain voltage applied to the first electrode layer 411b and the second electrode layer 411c in a certain temperature atmosphere, or a temperature atmosphere that may be changed from a high temperature to a room temperature, but embodiments of the present disclosure are not limited thereto. For example, a polarization direction of the vibration layer 411a may be formed to be or aligned (or arranged) from the first electrode layer 411b to the second electrode layer 411c, but is not limited thereto, and a polarization direction of the vibration layer 411a may be formed to be or aligned (or arranged) from the second electrode layer 411c to the first electrode layer 411b.

The vibration layer 411a may alternately and repeatedly contract and/or expand based on an inverse piezoelectric effect according to a piezoelectric driving signal applied to the first electrode layer 411b and the second electrode layer 411c from an outside to vibrate. For example, the vibration layer 411a may vibrate in a vertical direction (or a thickness direction) and in a planar direction by signals applied to the first electrode layer 411b and the second electrode layer 411c. The vibration layer 411a may be displaced (or vibrated or driven) by contraction and/or expansion of the planar direction, thereby improving a sound characteristic and/or a sound pressure level characteristic of the vibration element 151b and 351b.

The vibration element 151b and 351b according to an embodiment of the present disclosure may further include a cover member 413.

The cover member 413 may be configured to cover at least one of a first surface and a second surface of the vibration part 411. The cover member 413 may be configured to protect at least one of the first surface and the second surface of the vibration part 411. For example, the first surface of the vibration part 411 may be a front surface or an upper surface. For example, the second surface of the vibration part 411 may be a rear surface or a lower surface which are opposite to the first surface.

The cover member 413 according to an embodiment of the present disclosure may include a first cover member 413a.

The first cover member 413a may be disposed at the first surface of the vibration part 411. For example, the first cover member 413a may be configured to cover the first electrode layer 411b of the vibration part 411. For example, the first cover member 413a may be configured to have a larger size than the vibration part 411, but embodiments of the present disclosure are not limited thereto. The first cover member 413a may be configured to protect the first surface of the vibration part 411 and the first electrode layer 411b.

The first cover member 413a according to an embodiment of the present disclosure may include an adhesive layer. For example, the first cover member 413a may include a base film, and an adhesive layer which is in the base film and is connected or coupled to the first surface of the vibration part 411. For example, the adhesive layer may include an electrical insulating material which has adhesive properties and is capable of compression and decompression, but embodiments of the present disclosure are not limited thereto.

The first cover member 413a according to another embodiment of the present disclosure may be connected or coupled to the first surface of the vibration part 411 by a first adhesive layer 413b. For example, the first cover member 413a may be connected or coupled to the first surface or the first electrode layer 411b of the vibration part 411 by the first adhesive layer 413b. For example, the first cover member 413a may be connected or coupled to the first surface or the first electrode layer 411b of the vibration part 411 by a film laminating process by the first adhesive layer 13b. The first adhesive layer 413b may be configured to surround an entire first surface or a portion of a lateral surface of the vibration part 411.

The cover member 413 according to an embodiment of the present disclosure may include a second adhesive layer 413c.

The second adhesive layer 413c may be disposed at the second surface of the vibration part 411. For example, the second adhesive layer 413c may be configured to cover the second electrode layer 411c of the vibration part 411. The second adhesive layer 413c may be configured to protect the second surface and the second electrode layer 411c of the vibration part 411. The second adhesive layer 413c may be configured to surround an entire second surface or a portion of a lateral surface of the vibration part 411. For example, the second adhesive layer 413c may be a protection layer or a protection member, but embodiments of the present disclosure are not limited thereto.

The second adhesive layer 413c may be connected or coupled to the first adhesive layer 413b in the lateral surface of the vibration part 411 or a periphery portion of the first cover member 413a. Thus, the first adhesive layer 413b and the second adhesive layer 413c may be configured to surround or completely surround the vibration part 411. The first adhesive layer 413b and the second adhesive layer 413c may be configured to cover or surround all surfaces of the vibration part 411. For example, the vibration part 411 may be inserted (or accommodated) or embedded (or built-in) at an inner portion of the adhesive layer including the first adhesive layer 413b and the second adhesive layer 413c.

The cover member 413 according to an embodiment of the present disclosure may further include a second cover member 413d, but embodiments of the present disclosure are not limited thereto. The second cover member 413d may be disposed at the second surface of the vibration part 411. For example, the second cover member 413d may be configured to cover the second electrode layer 411c of the vibration part 411. For example, the second cover member 413d may be configured to have a larger size than the vibration part 411 and may be configured to have a same size as the first cover member 413a, but embodiments of the present disclosure are not limited thereto. The second cover member 413d may be configured to protect the second surface and the second electrode layer 411c of the vibration part 411.

The first cover member 413a and the second cover member 413d according to an embodiment of the present disclosure may include a same material or a different material. For example, each of the first cover member 413a and the second cover member 413d may be a polyimide film, a polyethylene naphthalate film, or a polyethylene terephthalate film, but embodiments of the present disclosure are not limited thereto.

The second cover member 413d may be connected or coupled to the second surface or the second electrode layer 411c of the vibration part 411 by using the second adhesive layer 413c. For example, the second cover member 413d may be connected or coupled to the second surface or the second electrode layer 411c of the vibration part 411 by a film laminating process by the second adhesive layer 413c.

The vibration part 411 may be disposed or inserted (or accommodated) between the first cover member 413a and the second cover member 413d. For example, the vibration part 411 may be inserted (or accommodated) or embedded (or built-in) at an inner portion of the adhesive layer including the first adhesive layer 413b and the second adhesive layer 413c, but embodiments of the present disclosure are not limited thereto.

Each of the first adhesive layer 413b and the second adhesive layer 413c according to an embodiment of the present disclosure may include an electrical insulating material which has adhesive properties and is capable of compression and decompression. For example, each of the first adhesive layer 413b and the second adhesive layer 413c may include epoxy resin, acrylic resin, silicone resin, urethane resin, a pressure sensitive adhesive (PSA), an optically cleared adhesive (OCA), or an optically cleared resin (OCR), or the like, but embodiments of the present disclosure are not limited thereto.

The first adhesive layer 413b and the second adhesive layer 413c may be configured between the first cover member 413a and the second cover member 413d to surround the vibration part 411. For example, one or more of the first adhesive layer 413b and the second adhesive layer 413c may be configured to surround the vibration part 411.

The vibration element 151b and 351b according to an embodiment of the present disclosure may further include a signal supply member 417.

The signal supply member 417 may be configured to supply a driving signal supplied from a driving circuit part to the vibration part 411. The signal supply member 417 may be configured to be electrically connected to the vibration part 411. The signal supply member 417 may be configured to be electrically connected to the first electrode layer 411b and the second electrode layer 411c of the vibration part 411.

A portion of the signal supply member 417 may be accommodated (or inserted) between the cover member 413 and the vibration part 411. For example, the portion of the signal supply member 417 may be accommodated (or inserted) between the first surface of the vibration part 411 and the first cover member 413a. For example, the portion of the signal supply member 417 may be accommodated (or inserted) between the first cover member 413a and the second cover member 413d, but embodiments of the present disclosure are not limited thereto.

According to an embodiment of the present disclosure, an end portion (or a distal end portion or one side) of the signal supply member 417 may be disposed or inserted (or accommodated) between one periphery portion of the cover member 413 and the vibration part 411. For example, the end portion of the signal supply member 417 may be disposed or inserted (or accommodated) between one periphery portion of the first cover member 413a and the first surface of the vibration part 411. For example, the signal supply member 417 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but embodiments of the present disclosure are not limited thereto.

The signal supply member 417 according to an embodiment of the present disclosure may include a base member 417a and a plurality of signal lines 417b and 417c. For example, the signal supply member 417 may include a base member 417a, a first signal line 417b, and a second signal line 417c.

The base member 417a may include a transparent or opaque plastic material, but embodiments of the present disclosure are not limited thereto.

The first and second signal lines 417b and 417c may be disposed at a first surface of the base member 417a and may be spaced apart from each other or electrically separated from each other. The first and second signal lines 417b and 417c may be disposed in parallel to each other at the first surface of the base member 417a. For example, the first and second signal lines 417b and 417c may be implemented in a line shape by patterning of a metal layer (or a conductive layer) formed or deposited at the first surface of the base member 417a.

End portions (or distal end portions or one sides) of the first and second signal lines 417b and 417c may be separated from each other, and thus, may be individually curved or bent.

The end portion of the first signal line 417b may be electrically connected to the first electrode layer 411b of the vibration part 411. For example, the end portion of the first signal line 417b may be electrically connected to at least a portion of the first electrode layer 411b of the vibration part 411 in the one periphery portion of the first cover member 413a. For example, the end portion of the first signal line 417b may be electrically and directly connected to at least a portion of the first electrode layer 411b of the vibration part 411. For example, the end portion of the first signal line 417b may be electrically connected to or directly contact the first electrode layer 411b of the vibration part 411. For example, the end portion of the first signal line 417b may be electrically connected to the first electrode layer 411b through a conductive double-sided tape. Accordingly, the first signal line 417b may be configured to supply a first driving signal, supplied from the driving circuit part, to the first electrode layer 411b of the vibration part 411.

The end portion of the second signal line 417c may be electrically connected to the second electrode layer 411c of the vibration part 411. For example, the end portion of the second signal line 417c may be electrically connected to at least a portion of the second electrode layer 411c of the vibration part 411 in one periphery portion of the second cover member 413d. For example, the end portion of the second signal line 417c may be electrically and directly connected to at least a portion of the second electrode layer 411c of the vibration part 411. For example, the end portion of the second signal line 417c may be electrically connected to or directly contact the second electrode layer 411c of the vibration part 411. For example, the end portion of the second signal line 417c may be electrically connected to the second electrode layer 411c through a conductive double-sided tape. Accordingly, the second signal line 417c may be configured to supply a second driving signal, supplied from the driving circuit part, to the second electrode layer 411c of the vibration part 411.

The signal supply member 417 according to an embodiment of the present disclosure may further include an insulation layer 417d.

The insulation layer 417d may be disposed at the first surface of the base member 417a to cover each of the first signal line 417b and the second signal line 417c other than the end portion (or one side) of the signal supply member 417.

According to an embodiment of the present disclosure, an end portion (or one side) of the signal supply member 417 including an end portion (or one side) of the base member 417a and an end portion (or one side) of the insulation layer 417d may be inserted (or accommodated) between the cover member 413 and the vibration part 411 and may be fixed between the cover member 413 (or first cover member 413a) and the vibration part 411 by the first adhesive layer 413b and the second adhesive layer 413c.

According to another embodiment of the present disclosure, an end portion (or one side) of the signal supply member 417 including an end portion of the base member 417a and an end portion of the insulation layer 417d may be inserted (or accommodated) between the first cover member 413a and the second cover member 413d and may be fixed between the first cover member 413a and the second cover member 413d by the first adhesive layer 413b and the second adhesive layer 413c. Accordingly, the end portion of the first signal line 417b may be maintained with being electrically connected to the first electrode layer 411b of the vibration part 411, and the end portion of the second signal line 417c may be maintained with being electrically connected to the second electrode layer 411c of the vibration part 411. In addition, the end portion of the signal supply member 417 may be inserted (or accommodated) and fixed between the vibration part 411 and the first cover member 413a, and thus, a contact defect between the vibration element 151b and 351b and the signal supply member 417 caused by the movement of the signal supply member 417 may be prevented.

In the signal supply member 417 according to an embodiment of the present disclosure, each of the end portion of the base member 417a and the end portion 417da of the insulation layer 417d may be removed. For example, each of the end portion of the first signal line 417b and the end portion of the second signal line 417c may be exposed at the outside without being supported or covered by each of the end portion of the base member 417a and the end portion 417da of the insulation layer 417d, respectively. For example, the end portion of each of the first signal line 417b and the second signal line 417c may protrude (or extend) to have a certain length from an end of the base member 417a or an end of the insulation layer 417d. Accordingly, each of the end portion of each of the first signal line 417b and the second signal line 417c may be individually or independently bent.

The end portion of the first signal line 417b, which is not supported by the end portion of the base member 417a and the end portion of the insulation layer 417d, may be directly connected to or directly contact the first electrode layer 411b of the vibration part 411. The end portion of the second signal line 417c, which is not supported by the end portion of the base member 417a and the end portion of the insulation layer 417d, may be directly connected to or directly contact the second electrode layer 411c of the vibration part 411.

According to an embodiment of the present disclosure, a portion of the signal supply member 417 or a portion of the base member 417a may be disposed or inserted (or accommodated) between the cover member 413 and the vibration part 411, and thus, the signal supply member 417 may be integrated as one body with the vibration part 411. Further, a portion of the signal supply member 417 or a portion of the base member 417a may be disposed or inserted (or accommodated) between the first cover member 413a and the second cover member 413d, and thus, the signal supply member 417 may be integrated as one body with the vibration element 151b and 351b. Accordingly, the vibration element 151b and 351b and the signal supply member 417 may be configured as one part (or one element or one component), and thus, an effect of uni-materialization may be obtained.

According to an embodiment of the present disclosure, the first signal line 417b and the second signal line 417c of the signal supply member 417 may be integrated as one body with the vibration element 151b and 351b, and thus, a soldering process for an electrical connection between the vibration element 151b and 351b and the signal supply member 417 is not be needed. Accordingly, a manufacturing process and a structure of the vibration element 151b and 351b may be simplified, and hazards associated with the soldering process may be reduced.

FIG. 20 is a perspective view illustrating a vibration layer according to another embodiment of the present disclosure. For example, FIG. 20 illustrates another embodiment of the vibration layer described above with reference to FIGS. 17 to 19.

Referring to FIGS. 18 and 20, the vibration layer 411a according to another embodiment of the present disclosure may include a plurality of first portions 411a1 and a plurality of second portions 411a2. For example, the plurality of first portions 411a1 and the plurality of second portions 411a2 may be alternately and repeatedly disposed along a first direction X (or second direction Y).

Each of the plurality of first portions 411a1 may include an inorganic material portion having a piezoelectric effect (or a piezoelectric characteristic). For example, each of the plurality of first portions 411a1 may include at least one of a piezoelectric inorganic material and a piezoelectric organic material. For example, each of the plurality of first portions 411a1 may be an inorganic portion, an inorganic material portion, a piezoelectric portion, a piezoelectric material portion, or an electroactive portion, but embodiments of the present disclosure are not limited thereto.

According to an embodiment of the present disclosure, each of the plurality of first portions 411a1 may have a first width W1 parallel to the first direction X (or the second direction Y) and may be extended along the second direction Y (or the first direction X). Each of the plurality of first portions 411a1 may be substantially a same as the vibration layer 411a described above with reference to FIGS. 17 to 19, and thus, its repeated descriptions are omitted.

Each of the plurality of second portions 411a2 may be disposed between the plurality of first portions 411a1. For example, each of the plurality of first portions 411a1 may be disposed between two adjacent second portions 411a2 of the plurality of second portions 411a2. Each of the plurality of second portions 411a2 may have a second width W2 parallel to the first direction X (or the second direction Y) and may be extended along the second direction Y (or the first direction X). The first width W1 may be a same as or different from the second width W2. For example, the first width W1 may be greater than the second width W2. For example, the first portion 411a1 and the second portion 411a2 may include a line shape or a stripe shape which has a same size or different sizes, but embodiments of the present disclosure are not limited thereto.

Each of the plurality of second portions 411a2 may be configured to fill a gap between two adjacent first portions of the plurality of first portions 411al. Each of the plurality of second portions 411a2 may be configured to fill a gap between two adjacent first portions of the plurality of first portions 411al, and thus, may be connected to or attached at lateral surfaces of the first portion 411a1 adjacent thereto. According to an embodiment of the present disclosure, each of the plurality of first portions 411a1 and the plurality of second portions 411a2 may be disposed (or arranged) at a same plane (or a same layer) in parallel with each other. Therefore, the vibration layer 411a may be expanded to a desired size or length by a lateral coupling (or connection) of the first portions 411a1 and the second portions 411a2.

According to an embodiment of the present disclosure, each of the plurality of second portions 411a2 may absorb an impact applied to the first portions 411al, and thus, may enhance the total durability of the first portions 411a1 and provide flexibility to the vibration layer 411a. Each of the plurality of second portions 411a2 may include an organic material having a ductile characteristic. For example, each of the plurality of second portions 411a2 may include one or more of an epoxy-based polymer, an acrylic-based polymer, and a silicone-based polymer, but embodiments of the present disclosure are not limited thereto. For example, each of the plurality of second portions 411a2 may be an organic portion, an organic material portion, an adhesive portion, a stretch portion, a bending portion, a damping portion, or a ductile portion, but embodiments of the present disclosure are not limited thereto.

A first surface of each of the plurality of first portions 411a1 and the plurality of second portions 411a2 may be connected to the first electrode layer 411b in common. A second surface of each of the plurality of first portions 411a1 and the plurality of second portions 411a2 may be connected to the second electrode layer 411c in common.

The plurality of first portions 411a1 and the plurality of second portion 411a2 may be disposed (or connected) at a same plane, and thus, the vibration part 411a according to another embodiment of the present disclosure may have a single thin film-type. Accordingly, the vibration layer 411 or the vibration element 151b and 351b including the vibration layer 411a according to another embodiment of the present disclosure may vibrate by the first portion 411a1 having a vibration characteristic and may be bent in a curved shape by the second portion 411a2 having flexibility.

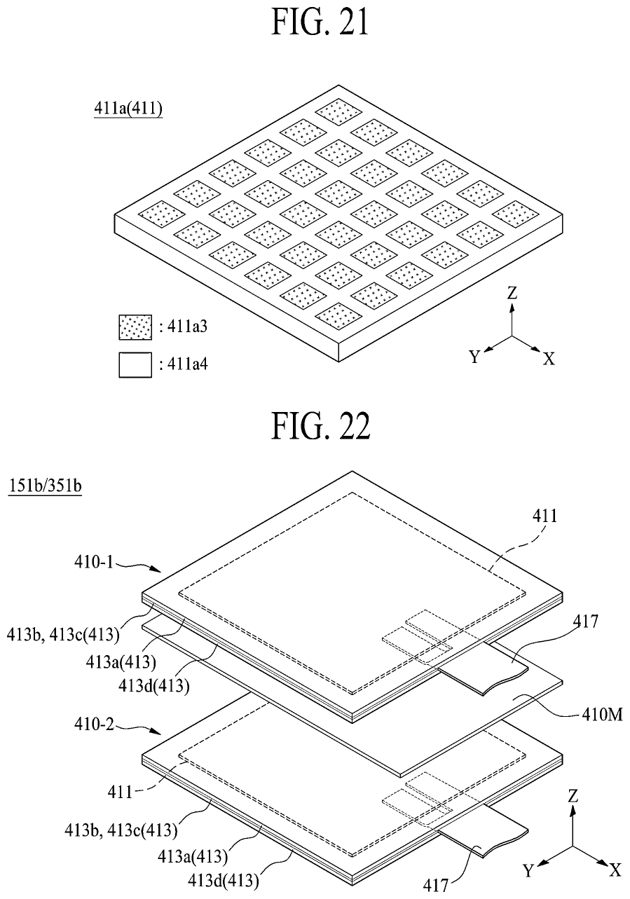

FIG. 21 is a perspective view illustrating a vibration layer according to another embodiment of the present disclosure. For example, FIG. 21 illustrates another embodiment of the vibration layer described above with reference to FIGS. 17 to 19.

Referring to FIGS. 18 and 21, the vibration layer 411a according to another embodiment of the present disclosure may include a plurality of first portions 411a3 and a second portion 411a4 disposed between the plurality of first portions 411a3.

Each of the plurality of first portions 411a3 may be disposed to be spaced apart from one another along each of the first direction X and the second direction Y. For example, each of the plurality of first portions 411a3 may have a hexahedral shape having a same size and may be disposed in a lattice shape, but embodiments of the present disclosure are not limited thereto. For example, each of the plurality of first portions 411a3 may have a circular shape plate, an oval shape plate, or a polygonal shape plate, which has a same size as each other, but embodiments of the present disclosure are not limited thereto.

Each of the plurality of first portions 411a3 may be substantially a same as the first portion 411a1 described above with reference to FIG. 20, and thus, its repeated descriptions are omitted.

The second portion 411a4 may be disposed between the plurality of first portions 411a3 along each of the first direction X and the second direction Y. The second portion 411a4 may be configured to fill a gap between two adjacent first portions 411a3, or to be adjacent to each of the plurality of first portions 411a3 or to surround each of the plurality of first portions 411a3, and thus, the second portion 411a4 may be connected to or attached at the first portion 411a3 adjacent thereto. The second portion 411a4 may be substantially a same as the second portion 411a2 described above with reference to FIG. 20, and thus, its repeated descriptions are omitted.

A first surface of each of the plurality of first portions 411a3 and the second portion 411a4 may be connected to the first electrode layer 411b in common. A second surface of each of the plurality of first portions 411a3 and the second portion 411a4 may be connected to the second electrode layer 411c in common.

The plurality of first portions 411a3 and the second portion 11a4 may be disposed (or connected) at a same plane, and thus, the vibration layer 411a according to another embodiment of the present disclosure may have a single thin film-type, but embodiments of the present disclosure are not limited thereto. Accordingly, the vibration part 411 of the vibration element 151b and 351b including the vibration layer 411a according to another embodiment of the present disclosure may vibrate by the first portions 411a3 having a vibration characteristic and may be bent in a curved shape by the second portion 411a4 having flexibility.

FIG. 22 is a perspective view illustrating a vibration apparatus according to another embodiment of the present disclosure. For example, FIG. 22 illustrates the vibration element of the vibration apparatus described above with reference to FIGS. 1 to 13.

Referring to FIG. 22, the vibration element 151b and 351b according to another embodiment of the present disclosure may include two or more vibration generating parts 410-1 and 410-2. For example, the vibration element 151b and 351b may include a first vibration generating part 410-1 and a second vibration generating part 410-2.

The first vibration generating part 410-1 and the second vibration generating part 410-2 may overlap or be stacked with each other to be displaced (or driven or vibrated) in a same direction to maximize an amplitude displacement of the vibration apparatus 10 or an amplitude displacement of the vibration member. For example, the first vibration generating part 410-1 and the second vibration generating part 410-2 may have substantially a same size, but embodiments of the present disclosure are not limited thereto. For example, the first vibration generating part 410-1 and the second vibration generating part 410-2 may have substantially a same size within an error range of a manufacturing process. Therefore, the first vibration generating part 410-1 and the second vibration generating part 410-2 may maximize the amplitude displacement of the vibration element 151b and 351b and/or the amplitude displacement of the vibration member.

Each of the first vibration generating part 410-1 and the second vibration generating part 410-2 may be a same as or substantially a same as the vibration element 151b and 351b described above with reference to FIGS. 17 to 21, and thus, like reference numeral refer to like element and its repeated descriptions are omitted.

The vibration element 151b and 351b according to another embodiment of the present disclosure may further include an intermediate member 410M.

The intermediate member 410M may be disposed or connected between the first vibration generating part 410-1 and the second vibration generating part 410-2. As an embodiment of the present disclosure, the intermediate member 410M may be disposed or connected between the second adhesive layer 413c of the first vibration generating part 410-1 and the first cover member 413a of the second vibration generating part 410-2. As another embodiment of the present disclosure, the intermediate member 410M may be disposed or connected between the second cover member 413d of the first vibration generating part 410-1 and the first cover member 413a of the second vibration generating part 410-2. For example, the intermediate member 410M may be an intermediate adhesive member, an adhesive member, or a connection member, but embodiments of the present disclosure are not limited thereto.

The intermediate member 410M according to an embodiment of the present disclosure may be configured in a material including an adhesive layer which is good in adhesive force or attaching force with respect to each of the first vibration generating part 410-1 and the second vibration generating part 410-2, but embodiments of the present disclosure are not limited thereto. For example, the intermediate member 410M may include a foam pad, a double-sided tape, a double-sided foam tape, a double-sided foam pad, a double-sided adhesive tape, or an adhesive, or the like, but embodiments of the present disclosure are not limited thereto. For example, an adhesive layer of the intermediate member 410M may include epoxy, acrylic, silicone, or urethane, but embodiments of the present disclosure are not limited thereto. For example, the adhesive layer of the intermediate member 410M may include a urethane-based material (or substance) having relatively ductile characteristic. Accordingly, the vibration loss caused by displacement interference between the first vibration generating part 410-1 and the second vibration generating part 410-2 may be reduced or minimized, or each of the first vibration generating part 410-1 and the second vibration generating part 410-2 may be freely displaced (or vibrated or driven).

The vibration element 151b and 351b according to another embodiment of the present disclosure may include the first vibration generating part 410-1 and the second vibration generating part 410-2 which are stacked (or piled or overlap) to vibrate (or displace or drive) in a same direction, and thus, the amount of displacement or an amplitude displacement may be maximized or increase. Accordingly, the amount of displacement (or a bending force or a driving force) or an amplitude displacement of the vibration member may be more maximized or more increased, thereby more enhancing a sound characteristic and/or a sound pressure level characteristic of a low-pitched sound band.

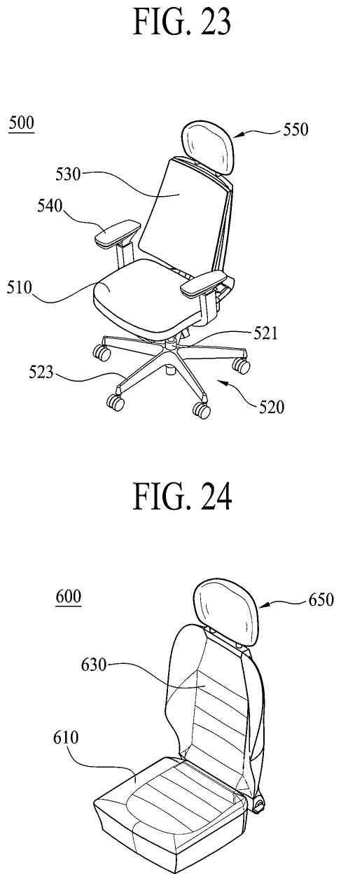

FIG. 23 is a perspective view illustrating a chair according to an embodiment of the present disclosure.

Referring to FIG. 23, the chair 500 according to an embodiment of the present disclosure may be a studying chair, an office chair, or a gaming chair, but embodiments of the present disclosure are not limited thereto.

The chair 500 according to an embodiment of the present disclosure may include a seat part 510, a backseat part 530, and a headrest 550.

The seat part 510 may be configured to enable a user to sit down. The seat part 510 may include a seat frame and a cushion seat supported by the seat frame.

The backseat part 530 may be configured to be connected (or coupled) to one side of the seat part 510. For example, the backseat part 530 may include a backseat frame connected to one side of the seat part 510 and a backseat cushion configured at a front surface of the backseat frame. For example, the backseat part 530 may be configured to rotate (or tilt) with respect to one side of the seat part 510.

The headrest 550 may be configured to be connected to (or supported by) an upper portion of the backseat part 530. The headrest 550 may be configured to output a sound to a user who sits on the seat part 510. The headrest 550 according to an embodiment of the present disclosure may be configured to include the headrest 10 described above with reference to FIGS. 1 to 13 and 17 to 22, and thus, its repeated descriptions are omitted. The headrest 550 according to another embodiment of the present disclosure may be configured to include the headrest 20 described above with reference to FIGS. 14 to 22, and thus, its repeated descriptions are omitted.

The chair 500 according to an embodiment of the present disclosure may further include a seat supporting portion 530. The seat supporting portion 530 may include a vertical supporting portion 521 and a plurality of horizontal supporting portions 523.

The vertical supporting portion 521 may be vertically connected (or coupled) to the seat frame of the seat part 510. For example, the vertical supporting portion 521 may be configured to adjust a height of the seat part 510.

The plurality of horizontal supporting portions 523 may be supported by the ground and may be connected (or coupled) to the vertical supporting portion 521 in common. For example, the plurality of horizontal supporting portions 523 may be connected (or coupled) to the vertical supporting portion 521 to have a radial shape with respect to the vertical supporting portion 521, so as to stably maintain a vertical state of the vertical supporting portion 521.

The seat supporting portion 530 may further include a plurality of roller portions 525. The plurality of roller portions 525 may be respectively connected (or coupled) to the plurality of horizontal supporting portions 523. The plurality of roller portions 525 may rotate based on the movement of the chair 500 with contacting the ground. The movement of the chair 500 may be easy, based on rotations of the plurality of roller portions 525.

The chair 500 according to an embodiment of the present disclosure may further include a pair of armrests 540.

The pair of armrests 540 may be configured to support an arm of a user who sits on the seat part 510. For example, the pair of armrests 540 may be disposed (or configured) at one side (or left side) and the other side (or right side) of the seat part 510.

The chair 500 according to an embodiment of the present disclosure may provide, through the headrest 550, a sound to a user who sits on the seat part 510. For example, the chair 500 may provide, through the headrest 550, a 2-channel stereo sound including a left channel sound and a right channel sound or a 3-channel stereo sound or stereophonic sound to the user who sits on the seat part 510.

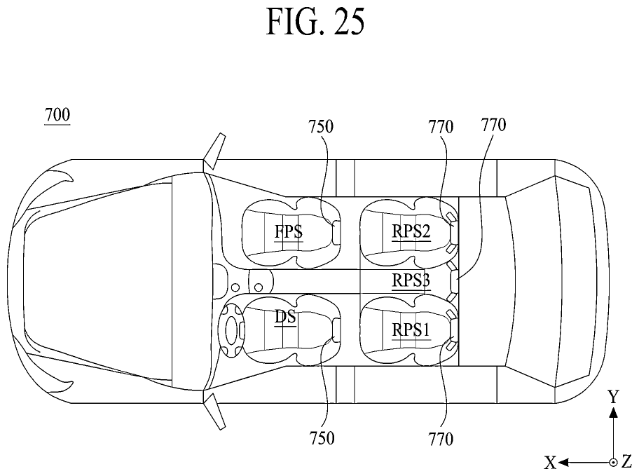

FIG. 24 is a perspective view illustrating a seat for vehicular apparatus according to an embodiment of the present disclosure.

Referring to FIG. 24, the seat 600 for vehicular apparatus according to an embodiment of the present disclosure may be a driver seat, a passenger seat, a back seat, or a buggy seat, but embodiments of the present disclosure are not limited thereto.

The seat 600 for vehicular apparatus according to an embodiment of the present disclosure may include a seat cushion 610, a seat back 630, and a headrest 650.

The seat cushion 610 be configured to enable a passenger in a vehicular apparatus to sit down. The seat cushion 610 may include a seat frame and a seat cushion supported by the seat frame.

The seat back 630 may be configured to be connected (or coupled) to one side of the seat cushion 610. For example, the seat back 630 may include a seat back frame connected (or coupled) to one side of the seat cushion 610 and a seat back cushion configured at a front surface of the seat back frame. For example, the seat back 630 may be configured to rotate (or tilt) with respect to one side of the seat cushion 610.

The headrest 650 may be configured to be connected to (or supported by) an upper portion of the seat cushion 630. The headrest 550 may be configured to output a sound to a passenger who sits on the seat cushion 630. The headrest 650 according to an embodiment of the present disclosure may be configured to include the headrest 10 described above with reference to FIGS. 1 to 13 and 17 to 22, and thus, its repeated descriptions are omitted. The headrest 650 according to another embodiment of the present disclosure may be configured to include the headrest 20 described above with reference to FIGS. 14 to 22, and thus, its repeated descriptions are omitted.

The seat 600 for vehicular apparatus according to an embodiment of the present disclosure may provide, through the headrest 650, a sound to a passenger who sits on the seat cushion 610. For example, the seat 600 for vehicular apparatus may provide, through the headrest 650, a 2-channel stereo sound including a left channel sound and a right channel sound or a 3-channel stereo sound or stereophonic sound to the passenger who sits on the seat cushion 610.

FIG. 25 is a plan view illustrating a vehicular apparatus 700 according to an embodiment of the present disclosure.

The vehicular apparatus 700 according to an embodiment of the present disclosure may include a driver seat DS, a front passenger seat FPS, and a plurality of rear passenger seats RPS1, RPS2, and RPS3.

The driver seat DS and the front passenger seat FPS may each be a front seat. Each of the driver seat DS and the front passenger seat FPS may include a headrest 750.

The headrest 750 of each of the driver seat DS and the front passenger seat FPS according to an embodiment of the present disclosure may be configured to include the headrest 10 described above with reference to FIGS. 1 to 13 and 17 to 22, and thus, their repeated descriptions are omitted.

The headrest 750 of each of the driver seat DS and the front passenger seat FPS according to another embodiment of the present disclosure may be configured to include the headrest 20 described above with reference to FIGS. 14 to 22, and thus, their repeated descriptions are omitted.

The headrest 750 of the driver seat DS may provide a driver with a 2-channel stereo sound including a left channel sound and a right channel sound or a 3-channel stereo sound or stereophonic sound.

The headrest 750 of the front passenger seat FPS may provide a 2-channel stereo sound including a left channel sound and a right channel sound or a 3-channel stereo sound or stereophonic sound to a passenger sitting on a front passenger seat.

Each of the plurality of rear passenger seats RPS1, RPS2, and RPS3 may include the headrest 770.

The headrest 770 of each of the plurality of rear passenger seats RPS1, RPS2, and RPS3 according to an embodiment of the present disclosure may be configured to include the headrest 10 described above with reference to FIGS. 1 to 13 and 17 to 22, and thus, their repeated descriptions are omitted.

The headrest 770 of each of the driver seat DS and the front passenger seat FPS according to another embodiment of the present disclosure may be configured to include the headrest 20 described above with reference to FIGS. 14 to 22, and thus, their repeated descriptions are omitted.

The headrest 770 of each of the plurality of rear passenger seats RPS1, RPS2, and RPS3 may provide a 2-channel stereo sound including a left channel sound and a right channel sound or a 3-channel stereo sound or stereophonic sound to a passenger sitting on each of a plurality of rear passenger seats.

According to another embodiment of the present disclosure, the vehicular apparatus 700 may be configured to include the seat 600 for vehicular apparatus described above with reference to FIG. 24. For example, one or more of the driver seat DS, the front passenger seat FPS, and the plurality of rear passenger seats RPS1, RPS2, and RPS3 may be configured to include the seat 600 for vehicular apparatus described above with reference to FIG. 24, and thus, their repeated descriptions are omitted.

The vehicular apparatus 700 according to an embodiment of the present disclosure may provide a 2-channel stereo sound including a left channel sound and a right channel sound or a 3-channel stereo sound or stereophonic sound to a passenger sitting on a corresponding seat through the headrests 750 and 770 which are in one or more of the driver seat DS, the front passenger seat FPS, and the plurality of rear passenger seats RPS1, RPS2, and RPS3.

A headrest, and a chair and a vehicular apparatus including the same according to an embodiment of the present disclosure will be described below.

A headrest according to one or more embodiments of the present disclosure may comprise a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

According to one or more embodiments of the present disclosure, the sound generating apparatus may comprise a piezoelectric material.

According to one or more embodiments of the present disclosure, the headrest frame may comprise an accommodating portion accommodating the sound generating apparatus.

According to one or more embodiments of the present disclosure, the cushion member may comprise a hollow portion corresponding to the accommodating portion.

According to one or more embodiments of the present disclosure, the headrest may further comprise a cushion pad accommodated into the hollow portion of the cushion member.

According to one or more embodiments of the present disclosure, the headrest may further comprise a sound blocking member between a rear surface of the headrest frame and the sheath member.

According to one or more embodiments of the present disclosure, the sound generating apparatus may comprise a vibration member in the headrest frame, and a vibration element connected to the vibration member and configured to vibrate the vibration member.

According to one or more embodiments of the present disclosure, the sound generating apparatus may further comprise a cover disposed on the vibration element and configured to include a sound emission portion corresponding to the vibration element.

According to one or more embodiments of the present disclosure, the headrest may further comprise a cushion pad in the cushion member. The cushion member may comprise a hollow portion corresponding to the sound emission portion of the cover. The cushion pad may be between the sheath member and the cover and may be accommodated into the hollow portion.

According to one or more embodiments of the present disclosure, the headrest frame may comprise a base frame connected to the support rod part and including a first region, a second region parallel to the first region, and a third region surrounding the first region and the second region; a first accommodating portion in the first region of the base frame; and a second accommodating portion in the second region of the base frame.

According to one or more embodiments of the present disclosure, the sound generating apparatus may comprise a first vibration apparatus in the first accommodating portion of the headrest frame, and a second vibration apparatus in the second accommodating portion of the headrest frame.

According to one or more embodiments of the present disclosure, the first vibration apparatus and the second vibration apparatus may be configured to output different sounds.

According to one or more embodiments of the present disclosure, the first vibration apparatus may comprise a vibration member accommodated into the first accommodating portion of the headrest frame and connected to the headrest frame, and a vibration element connected to the vibration member and configured to vibrate the vibration member. The second vibration apparatus may comprise a vibration member accommodated into the second accommodating portion of the headrest frame and connected to the headrest frame, and a vibration element connected to the vibration member and configured to vibrate the vibration member.

According to one or more embodiments of the present disclosure, the vibration member may comprise one or more materials of metal, wood, rubber, plastic, carbon, glass, fiber, cloth, paper, a mirror, and leather.

According to one or more embodiments of the present disclosure, the vibration element may comprise a vibration part including a piezoelectric material, a cover member on at least one of a first surface of the vibration part and a second surface which is opposite to the first surface of the vibration part, and a signal supply member electrically connected to the vibration part.

According to one or more embodiments of the present disclosure, a portion of the signal supply member may be accommodated between the cover member and the vibration part.

According to one or more embodiments of the present disclosure, the sound generating apparatus may further comprise a cover configured to cover the first vibration apparatus and the second vibration apparatus. The cover may comprise a first sound emission portion having one or more holes overlapping the first vibration apparatus, and a second sound emission portion having one or more holes overlapping the second vibration apparatus.

According to one or more embodiments of the present disclosure, the cushion member may comprise a first hollow portion overlapping the first sound emission portion, and a second hollow portion overlapping the second sound emission portion.

According to one or more embodiments of the present disclosure, the headrest may further comprise a cushion pad in the cushion member. The cushion pad may comprise a first cushion pad accommodated into the first hollow portion, and a second cushion pad accommodated into the second hollow portion.

A headrest according to one or more embodiments of the present disclosure may comprise a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus may comprise an enclosure connected to the headrest part, a cushion member at a front surface of the enclosure, and a vibration apparatus configured between the enclosure and the cushion member to output a sound.

According to one or more embodiments of the present disclosure, the first sound generating apparatus and the second sound generating apparatus may be configured to output different sounds.

According to one or more embodiments of the present disclosure, the first sound generating apparatus may tilt at a first angle from the first lateral surface of the headrest part. The second sound generating apparatus may tilt at a second angle from the second lateral surface of the headrest part.

According to one or more embodiments of the present disclosure, the vibration apparatus may comprise a piezoelectric material.

According to one or more embodiments of the present disclosure, the headrest part may comprise a headrest frame, a cushion member at a front surface of the headrest frame, and a support rod part connected to the headrest frame.

According to one or more embodiments of the present disclosure, the enclosure may comprise an accommodating portion. The vibration apparatus may comprise a vibration member in the accommodating portion, and a vibration element connected to the vibration member and configured to vibrate the vibration member.

According to one or more embodiments of the present disclosure, the vibration member may comprise one or more materials of metal, wood, rubber, plastic, carbon, glass, fiber, cloth, paper, a mirror, and leather.

According to one or more embodiments of the present disclosure, the vibration element may comprise a vibration part including a piezoelectric material, a cover member on at least one of a first surface of the vibration part and a second surface which is opposite to the first surface of the vibration part, and a signal supply member electrically connected to the vibration part.

According to one or more embodiments of the present disclosure, a portion of the signal supply member may be accommodated between the cover member and the vibration part.

According to one or more embodiments of the present disclosure, each of the first sound generating apparatus and the second sound generating apparatus may further comprise a cover provided between the vibration apparatus and the cushion member and including a sound emission portion overlapping the vibration apparatus.

According to one or more embodiments of the present disclosure, each of the first sound generating apparatus and the second sound generating apparatus may further comprise a sound blocking member between the enclosure and the sheath member.

According to one or more embodiments of the present disclosure, the headrest may further comprise a third sound generating apparatus on the headrest part. The third sound generating apparatus may output a sound which differs from one or more the first sound generating apparatus and the second sound generating apparatus.

According to one or more embodiments of the present disclosure, the third sound generating apparatus may comprise any one or more of a woofer speaker, a mid-woofer speaker, and a sub-woofer speaker.

According to one or more embodiments of the present disclosure, the headrest may comprise a headrest frame configured to accommodate the third sound generating apparatus, a cushion member at a front surface of the headrest frame, and a support rod part connected to the headrest frame.

According to one or more embodiments of the present disclosure, the headrest frame may comprise a sound emission port outputting a sound generated by the third sound generating apparatus.

According to one or more embodiments of the present disclosure, the third sound generating apparatus may comprise a first enclosure accommodated into the headrest frame and including a sound space and a sound emission path, a second enclosure on the first enclosure, an actuator accommodated into the second enclosure and including a magnet and a coil, and a cover plate disposed on the actuator and connected to the second enclosure.

According to one or more embodiments of the present disclosure, the headrest frame may comprise an accommodating portion accommodating the third sound generating apparatus, a first sound emission port connected to the sound space of the third sound generating apparatus, and a second sound emission port connected to the sound emission path of the third sound generating apparatus.

According to one or more embodiments of the present disclosure, the headrest may further comprise a sound blocking member between the headrest frame and the sheath member.

A chair according to one or more embodiments of the present disclosure may comprise a seat part, a backseat part connected to the seat part, and a headrest connected to an upper portion of the backseat part. The headrest may comprise a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

A chair according to one or more embodiments of the present disclosure may comprise a seat part, a backseat part connected to the seat part, and a headrest connected to an upper portion of the backseat part. The headrest may comprise a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus may comprise an enclosure connected to the headrest part, a cushion member at a front surface of the enclosure, and a vibration apparatus configured between the enclosure and the cushion member to output a sound.

The seat for vehicular apparatus according to one or more embodiments of the present disclosure may comprise a seat cushion, a seat back connected to the seat cushion, and a headrest connected to an upper portion of the seat back. The headrest may comprise a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

The seat for vehicular apparatus according to one or more embodiments of the present disclosure may comprise a seat cushion, a seat back connected to the seat cushion, and a headrest connected to an upper portion of the seat back. The headrest may comprise a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus may comprise an enclosure connected to the headrest part, a cushion member at a front surface of the enclosure, and a vibration apparatus configured between the enclosure and the cushion member to output a sound.

A vehicular apparatus according to one or more embodiments of the present disclosure may comprise a seat for vehicular apparatus. The seat for vehicular apparatus may comprise a seat cushion, a seat back connected to the seat cushion, and a headrest connected to an upper portion of the seat back. The headrest may comprise a headrest frame, a support rod part connected to a lower surface of the headrest frame, a cushion member at a front surface of the headrest frame, a sound generating apparatus configured between the headrest frame and the cushion member to output a sound, and a sheath member on a rear surface and a lateral surface of the headrest frame and at a front surface and a lateral surface of the cushion pad.

A vehicular apparatus according to one or more embodiments of the present disclosure may comprise a seat for vehicular apparatus. The seat for vehicular apparatus may comprise a seat cushion, a seat back connected to the seat cushion, and a headrest connected to an upper portion of the seat back. The headrest may comprise a headrest part, a first sound generating apparatus connected to a first lateral surface of the headrest part, a second sound generating apparatus connected to a second lateral surface which is opposite to the first lateral surface of the headrest part, and a sheath member on the headrest part, the first sound generating apparatus, and the second sound generating apparatus. Each of the first sound generating apparatus and the second sound generating apparatus may comprise an enclosure connected to the headrest part, a cushion member at a front surface of the enclosure, and a vibration apparatus configured between the enclosure and the cushion member to output a sound.

It will be apparent to those skilled in the art that various modifications and variations can be made in the to the headrest and chair, the seat for a vehicular apparatus, and the vehicular apparatus including the same of the present disclosure without departing from the technical idea or scope of the disclosure. Thus, it is intended that the present disclosure cover the modifications and variations of this disclosure provided they come within the scope of the appended claims and their equivalents.

What is claimed is:

1. A headrest, comprising:
a headrest frame;
a support rod part connected to a lower surface of the headrest frame;
a cushion member at a front surface of the headrest frame;
a sound generating apparatus configured between the headrest frame and the cushion member to output a sound; and
a sheath member on a rear surface and a lateral surface of the headrest frame and at a front surface and a lateral surface of the cushion member.

2. The headrest of claim 1, wherein the sound generating apparatus comprises a piezoelectric material.

3. The headrest of claim 1, wherein the headrest frame comprises an accommodating portion accommodating the sound generating apparatus.

4. The headrest of claim 3, wherein the cushion member comprises a hollow portion corresponding to the accommodating portion.

5. The headrest of claim 4, further comprising a cushion pad accommodated into the hollow portion of the cushion member.

6. The headrest of claim 1, further comprising a sound blocking member between the rear surface of the headrest frame and the sheath member.

7. The headrest of claim 1, wherein the sound generating apparatus comprises:
a vibration member in the headrest frame; and
a vibration element connected to the vibration member and configured to vibrate the vibration member.

8. The headrest of claim 7, wherein the sound generating apparatus further comprises a cover disposed on the vibration element and configured to include a sound emission portion corresponding to the vibration element.

9. The headrest of claim 8, further comprising a cushion pad in the cushion member,
wherein the cushion member comprises a hollow portion corresponding to the sound emission portion of the cover, and
wherein the cushion pad is between the sheath member and the cover and is accommodated into the hollow portion.

10. The headrest of claim 1, wherein the headrest frame comprises:
a base frame connected to the support rod part and including a first region, a second region parallel to the first region, and a third region surrounding the first region and the second region;
a first accommodating portion in the first region of the base frame; and
a second accommodating portion in the second region of the base frame.

11. The headrest of claim 10, wherein the sound generating apparatus comprises:
a first vibration apparatus in the first accommodating portion of the headrest frame; and
a second vibration apparatus in the second accommodating portion of the headrest frame.

12. The headrest of claim 11, wherein the first vibration apparatus and the second vibration apparatus are configured to output different sounds.

13. The headrest of claim 11,
wherein the first vibration apparatus comprises:
a first vibration member accommodated into the first accommodating portion of the headrest frame and connected to the headrest frame; and
a first vibration element connected to the first vibration member and configured to vibrate the first vibration member, and
wherein the second vibration apparatus comprises:
a second vibration member accommodated into the second accommodating portion of the headrest frame and connected to the headrest frame; and
a second vibration element connected to the second vibration member and configured to vibrate the second vibration member.

14. The headrest of claim 13, wherein each of the first and second vibration members comprises one or more materials of metal, wood, rubber, plastic, carbon, glass, fiber, cloth, paper, a mirror, and leather.

15. The headrest of claim 13, wherein each of the first and second vibration elements comprises:
a vibration part including a piezoelectric material;
a cover member on at least one of a first surface of the vibration part and a second surface which is opposite to the first surface of the vibration part; and
a signal supply member electrically connected to the vibration part.

16. The headrest of claim 15, wherein a portion of the signal supply member is accommodated between the cover member and the vibration part.

17. The headrest of claim 11,
wherein the sound generating apparatus further comprises a cover configured to cover the first vibration apparatus and the second vibration apparatus, and
wherein the cover comprises:
a first sound emission portion having one or more holes overlapping the first vibration apparatus; and
a second sound emission portion having one or more holes overlapping the second vibration apparatus.

18. The headrest of claim 17, wherein the cushion member comprises:
a first hollow portion overlapping the first sound emission portion; and
a second hollow portion overlapping the second sound emission portion.

19. The headrest of claim 18, further comprising a cushion pad in the cushion member,
wherein the cushion pad comprises:
a first cushion pad accommodated into the first hollow portion; and
a second cushion pad accommodated into the second hollow portion.

20. A headrest, comprising:
a headrest part;
a first sound generating apparatus connected to a first lateral surface of the headrest part;
a second sound generating apparatus connected to a second lateral surface which is opposite to the first lateral surface of the headrest part; and
a sheath member on the headrest part, the first sound generating apparatus, and the second sound generating apparatus,
wherein each of the first sound generating apparatus and the second sound generating apparatus comprises:
an enclosure connected to the headrest part;
a cushion member at a front surface of the enclosure; and
a vibration apparatus configured between the enclosure and the cushion member to output a sound.

21. The headrest of claim 20, wherein the first sound generating apparatus and the second sound generating apparatus are configured to output different sounds.

22. The headrest of claim 20,
wherein the first sound generating apparatus tilts at a first angle from the first lateral surface of the headrest part, and
wherein the second sound generating apparatus tilts at a second angle from the second lateral surface of the headrest part.

23. The headrest of claim 20, wherein the vibration apparatus comprises a piezoelectric material.

24. The headrest of claim 20, wherein the headrest part comprises:
a headrest frame;
a cushion member at a front surface of the headrest frame; and
a support rod part connected to the headrest frame.

25. The headrest of claim 20,
wherein the enclosure comprises an accommodating portion; and
wherein the vibration apparatus comprises:
a vibration member in the accommodating portion; and
a vibration element connected to the vibration member and configured to vibrate the vibration member.

26. The headrest of claim 25, wherein the vibration member comprises one or more materials of metal, wood, rubber, plastic, carbon, glass, fiber, cloth, paper, a mirror, and leather.

27. The headrest of claim 25, wherein the vibration element comprises:
a vibration part including a piezoelectric material;
a cover member on at least one of a first surface of the vibration part and a second surface which is opposite to the first surface of the vibration part; and
a signal supply member electrically connected to the vibration part.

28. The headrest of claim 27, wherein a portion of the signal supply member is accommodated between the cover member and the vibration part.

29. The headrest of claim 20, wherein each of the first sound generating apparatus and the second sound generating apparatus further comprises a cover provided between the vibration apparatus and the cushion member and including a sound emission portion overlapping the vibration apparatus.

30. The headrest of claim 20, wherein each of the first sound generating apparatus and the second sound generating apparatus further comprises a sound blocking member between the enclosure and the sheath member.

31. The headrest of claim 20, further comprising a third sound generating apparatus on the headrest part,
wherein the third sound generating apparatus outputs a sound which differs from one or more the first sound generating apparatus and the second sound generating apparatus.

32. The headrest of claim 31, wherein the third sound generating apparatus comprises any one or more of a woofer speaker, a mid-woofer speaker, and a sub-woofer speaker.

33. The headrest of claim 31, wherein the headrest comprises:
a headrest frame configured to accommodate the third sound generating apparatus;
a cushion member at a front surface of the headrest frame; and
a support rod part connected to the headrest frame.

34. The headrest of claim 33, wherein the headrest frame comprises a sound emission port outputting a sound generated by the third sound generating apparatus.

35. The headrest of claim 33, wherein the third sound generating apparatus comprises:
a first enclosure accommodated into the headrest frame and including a sound space and a sound emission path;
a second enclosure on the first enclosure;
an actuator accommodated into the second enclosure and including a magnet and a coil; and
a cover plate disposed on the actuator and connected to the second enclosure.

36. The headrest of claim 35, wherein the headrest frame comprises:
an accommodating portion accommodating the third sound generating apparatus;
a first sound emission port connected to the sound space of the third sound generating apparatus; and
a second sound emission port connected to the sound emission path of the third sound generating apparatus.

37. The headrest of claim 20, further comprises a sound blocking member between the headrest part and the sheath member.

38. A headrest, comprising:
an enclosure including an accommodating portion and an opening front portion;
a sound generating apparatus accommodated in the accommodating portion;
a cushion member covering the opening front portion of the enclosure and including a hollow portion; and
a cushion pad disposed in the hollow portion of cushion member,
wherein the cushion pad includes a porous material.

39. The headrest of claim 38, wherein the sound generating apparatus comprises:
a vibration member coupled to the enclosure therein; and
a vibration element disposed on the vibration member and configured to vibrate the vibration member.

40. A chair, comprising:
a seat part;
a backseat part connected to the seat part; and
the headrest of claim 1 connected to an upper portion of the backseat part.

41. A seat for vehicular apparatus, comprising:
a seat cushion;
a seat back connected to the seat cushion; and
the headrest of claim 1 connected to an upper portion of the seat back.

42. A vehicular apparatus comprising the seat for vehicular apparatus of claim 41.
